(19) United States
(12) Patent Application Publication
(10) Pub. No.: US 2025/0236325 A1
(43) Pub. Date: Jul. 24, 2025

(54) TRANSPORT DEVICE AND CAMPING CART

(71) Applicant: Yuwen CHEN, Hangzhou (CN)

(72) Inventor: Yuwen CHEN, Hangzhou (CN)

(21) Appl. No.: 18/796,300

(22) Filed: Aug. 7, 2024

(30) Foreign Application Priority Data
Sep. 20, 2023 (CN) 202322564965.0
May 28, 2024 (CN) 202421184750.4

(51) Int. Cl. B62B 3/00; B62B 3/02; B62B 5/06

(52) U.S. Cl. CPC B62B 3/007; B62B 3/025; B62B 5/065; B62B 5/067; B62B 2205/06

(57) ABSTRACT

The disclosure discloses a transport device and camping cart. This design ingeniously incorporates a detachable support frame onto the chassis, combined with a storage assembly and casters to form a transport device, which can be used as an outdoor camping cart, providing flexible and convenient item transport functionality. Furthermore, the chassis can be configured in flat, multi-board, or foldable structures, with the pull rod designed to pivot in coordination with the chassis. When in use, this transport device can be easily deployed by extending the pull rod and adjusting the chassis. In its foldable form, the chassis uses a constraint assembly to achieve unidirectional locking or restriction during deployment, allowing the support frame and storage assembly to be independently detached when not in use. Additionally, the chassis can be folded and the pull rod flipped and folded, significantly reducing the space required for storing the transport device.

### CROSS-REFERENCE TO RELATED APPLICATIONS

This application claims a priority to Chinese Patent Application No. 202322564965.0, filed Sep. 20, 2023, entitled “TRANSPORT DEVICE AND CAMPING CART,” which is hereby incorporated by reference in its entirety.

### TECHNICAL FIELD

The present disclosure relates to the field of transport devices, and more particularly to a transport device and a camping cart.

### BACKGROUND OF THE INVENTION

A transport cart serves as an essential auxiliary tool for transferring items both indoors and outdoors. It provides users with labor-saving, time-efficient, and effective support when moving heavy or multiple items. However, in general daily use, the frequency of needing a transport cart for item transfer is not high. Therefore, enhancing the portability and compact storage of the transport cart is a matter of practical significance. Although some current products have achieved a reduction in vertical space occupation by folding the pull rods, the main space-occupying structure of the transport cart is its frame. Thus, merely folding the pull rods to improve storage convenience and reduce vertical space occupation still leaves room for improvement and expectations. This is especially true for users who place the transport cart in the car trunk for camping purposes. For camping carts, the frame often includes additional components such as storage boxes or bags for holding items to be transported, increasing the storage difficulty. If the frame and the supporting components of the storage assemblies could be structurally modified to maintain a good capacity for transporting items during use, while further reducing space occupation during storage, it would significantly enhance the user-friendliness and convenience of transport carts and camping carts.

### SUMMARY OF THE INVENTION

In view of the above, the object of the present disclosure is to propose a transport device and a camping cart that are easy to fold and store, flexible to use, and structurally reliable.

To achieve the above objects, the present disclosure provides a transport device.

The transport device includes a frame, casters, a pull rod, a support frame, and a storage assembly.

The casters are mounted on the lower part of the frame.

The pull rod is connected to one end of the frame and is used for pulling the frame to move.

The support frame is detachably connected to the upper end of the frame.

The storage assembly is mounted on the frame and is connected to the support frame, being used to accommodate items to be transported.

In one possible embodiment, the upper ends of both sides of the frame are provided with connection slots for fitting with the support frame. The lower end of the support frame can be detachably inserted into these connection slots.

The lower part of the storage assembly is detachably connected to the frame.

And/or, the connection slots have constraint holes, and the lower end of the support frame is equipped with constraint components corresponding to the constraint holes, which can be in locked or unlocked states.

In the locked state, the constraint components are inserted into the constraint holes, securing the lower end of the support frame within the connection slots.

In the unlocked state, the constraint components disengage from the constraint holes, allowing the lower end of the support frame to be removed from the connection slots.

The storage assembly includes a space for holding items to be transported, with its upper end detachably connected to the upper ends of the pair of support frames, and its lower end extending downward toward the frame.

As a possible embodiment of the support frame in this design, the support frame includes a first connecting frame and second connecting rods.

The first connecting frame consists of a pair of structures positioned opposite each other on both sides of the upper end of the frame. Each first connecting frame includes a pair of first connecting rods connected in a scissor-like manner. The lower ends of the first connecting rods correspond to the connection slots on the frame. The constraint components are located at the lower ends of the first connecting rods, and these rods are detachably connected to the connection slots via the constraint components.

The second connecting rods are arranged in parallel between the pair of first connecting frames. The ends of the second connecting rods are fixedly connected to the upper ends of the corresponding first connecting rods of the first connecting frames.

When the constraint components and the constraint holes are in a locked state, the constraint components engage with the constraint holes, securing the first connecting rods in the connection slots.

In the unlocked state, the constraint components disengage from the constraint holes, allowing the first connecting rods to be removed from the connection slots.

As another possible embodiment of the support frame, the support frame includes support rods and second connecting frames.

The support rods consist of two pairs, each pair positioned oppositely on both sides of the upper end of the frame. The lower ends of the support rods can be detachably inserted into the connection slots. The constraint components are located at the lower ends of the support rods, allowing them to be detachably connected to the connection slots via the constraint components.

The second connecting frames also consist of two pairs, each pair positioned oppositely between the adjacent support rods. Each second connecting frame includes a pair of second connecting rods connected in a scissor-like manner. The upper ends of each pair of second connecting rods are rotatably connected to the upper ends of the adjacent support rods. The lower ends of each pair of second connecting rods are slidably connected to the midsection of the adjacent support rods via sliding components, with the second connecting rods rotatably connected to the sliding components.

When the constraint components and the constraint holes are in a locked state, the constraint components engage with the constraint holes, securing the support rods in the connection slots.

In the unlocked state, the constraint components disengage from the constraint holes, allowing the support rods to be removed from the connection slots.

In the described structural arrangement, as one example of the implementation structure of the frame, the frame includes a chassis.

The chassis has a rectangular plate-like structure. The casters are mounted at the corners of the lower surface of the chassis. Opposite connection slots are provided on both sides of the upper end of the chassis.

The chassis includes a storage slot for accommodating the pull rod. One end of the storage slot extends to one end of the chassis. The pull rod is rotatably connected to one end of the storage slot.

In another possible embodiment of the chassis, the frame includes a first chassis, a second chassis, and guide rods.

The first chassis has a rectangular plate-like structure. The storage slot is located on the first chassis. Casters are provided at the corners of the lower surface of the first chassis.

The second chassis also has a rectangular plate-like structure. A pair of casters is provided on both sides of the lower end of the second chassis.

The guide rods are a pair arranged parallel and opposite to each other. One end of each guide rod is connected to the end of the second chassis near the first chassis. The first chassis has guide slots corresponding to the pair of guide rods, with the other ends of the guide rods slidably inserted into the guide slots.

The connection slots are located on the ends of the first and second chassiss that are spaced apart from each other.

Additionally, the guide slots are detachably equipped with locking members. Multiple locking holes are spaced along the length of the guide rods to cooperate with the locking members. The locking members and locking holes can be in a fixed state or a released state. In the fixed state, the locking members pass through the guide slots and engage with one of the locking holes, securing the guide rods in the guide slots. In the released state, the locking members disengage from the locking holes, allowing the guide rods to slide relative to the guide slots.

Alternatively, the bottom of the second chassis corresponding to one end of the guide rods has a connection part. This connection part is equipped with fixing components that engage with the guide rods. The ends of the guide rods inserted into the guide slots have anti-detachment parts to prevent the guide rods from slipping out of the guide slots.

In another structural embodiment of the frame, the frame is designed to fold or unfold along the width direction. The frame includes support rods, connecting assemblies, and constraint assemblies.

The support rods are a pair arranged horizontally opposite each other. The casters are connected to the lower ends of the support rods. The connection slots are provided at both ends of the support rods.

The connecting assemblies are connected to the pair of support rods and can move the support rods to fold or unfold the frame along the width direction.

The constraint assembly cooperates with at least one of the support rods and/or the connecting assembly, enabling the pair of support rods to maintain a locked state when unfolded or allowing the frame to be folded in the width direction when in an unlocked state.

In the described structural arrangement, as an example of the implementation structure of the connecting assembly, the connecting assembly includes a pair of first traction rods and a connecting seat.

The pair of first traction rods correspond to the pair of support rods, with one end of each first traction rod rotatably connected to one end of the support rods.

The connecting seat is positioned between the pair of first traction rods. The other ends of the first traction rods are rotatably connected to the connecting seat.

Additionally, one end of the pull rod is connected to the connecting seat via a rotating component, allowing the other end of the pull rod to flip up or down around the end connected to the connecting seat.

In the described structural arrangement, as a second example of the implementation structure of the connecting assembly, the connecting assembly further includes a pair of third connecting rods.

The third connecting rods are connected in the middle in a scissor-like manner. The pair of third connecting rods are positioned between the pair of support rods, with one end of each third connecting rod rotatably connected to the other end of the support rods. The other ends of the third connecting rods are connected via movable connecting components, allowing relative movement between the ends of the third connecting rods and the support rods.

When the constraint assembly and the connecting assembly are in an unlocked state, and the pair of support rods of the frame move toward or away from each other, the other ends of the third connecting rods move relative to the support rods, enabling the frame to fold or unfold along the width direction.

In one possible embodiment, the device further includes an installation assembly.

The installation assembly is arranged on the frame.

The support frame is connected to the frame through the installation assembly.

As a preferred embodiment, the frame includes support rods and a connecting assembly.

The support rods are arranged horizontally and opposite to each other. The casters are connected to the lower ends of the support rods.

The connecting assembly is connected to the pair of support rods, providing lateral support and enabling the support rods to move, thereby allowing the frame to fold or unfold along the width direction.

The connecting assembly is also connected to the installation assembly, which is equipped with a limit structure to restrict the width expansion of the frame.

As a preferred embodiment, the installation assembly includes a pair of first connecting blocks and a pair of second connecting blocks.

The pair of first connecting blocks correspond to the pair of support rods, with one end of each first connecting block provided with a slot that fits with one end of the support rods. The opposite side of the pair of first connecting blocks is equipped with a U-shaped rotating connection part.

The pair of second connecting blocks also correspond to the pair of support rods, with one end of each second connecting block provided with a slot that fits with the other end of the support rods.

The connecting assembly is rotatably connected to the U-shaped rotating connection parts of the pair of first connecting blocks. The closed side of the U-shaped structure forms a limit structure that restricts the rotational range of the connecting assembly relative to the rotating connection part.

The support frame is connected to the upper ends of the pair of first connecting blocks and the pair of second connecting blocks.

As a preferred embodiment, the support frame is detachably connected to the upper ends of the pair of first connecting blocks and the pair of second connecting blocks using fitting components. The upper ends of the first and second connecting blocks are each provided with lugs that cooperate with the fitting components. The lugs and the upper surfaces of the first or second connecting blocks form a constraint area, where the fitting components are inserted to engage detachably with the lugs. The support frame includes a pair of first connecting frames and a pair of second connecting rods.

The pair of first connecting frames are positioned opposite each other at the ends of the pair of support rods. Each first connecting frame includes a pair of first connecting rods connected in a scissor-like manner. One end of each pair of first connecting rods of one first connecting frame is detachably connected to the lugs on the upper end of the first connecting blocks at one end of the support rods, using fitting components. Similarly, the other first connecting frame's pair of first connecting rods are detachably connected to the lugs on the upper end of the second connecting blocks at the other end of the support rods.

The second connecting rods are a pair arranged parallel to each other between the pair of first connecting frames. The ends of the second connecting rods are fixedly connected to the upper ends of the corresponding first connecting rods of the first connecting frames.

The pair of second connecting rods and the pair of first connecting frames form a constrained space between them, designed to hold the storage assembly, which is connected to the pair of second connecting rods.

As a preferred embodiment, the fitting components include mounting sleeves.

The mounting sleeves are cylindrical housings that match the ends of the first connecting rods. The ends of the first connecting rods are inserted into the cylindrical housings of the mounting sleeves. The mounting sleeves are equipped with extension parts designed to insert into the constraint area and engage detachably with the lugs. The end of each extension part features an upward-bending hook. This hook cooperates with the lugs to prevent the mounting sleeve from detaching from the constraint area in a first direction. The first direction is perpendicular to or forms an angle with the direction in which the extension parts insert into the constraint area.

The upper end surface of the first or second connecting blocks is further provided with guide slots that direct the extension parts into the constraint area. The lower end surface of the extension parts features guide protrusions corresponding to the guide slots.

As a preferred embodiment, the support frame includes support rods and crossbars.

The support rods consist of two pairs, each pair corresponding to a pair of first connecting blocks and a pair of second connecting blocks. The upper ends of the first and second connecting blocks are equipped with rotating connection seats. One end of each pair of support rods is rotatably connected to the rotating connection seats on the upper ends of the corresponding first or second connecting blocks via rotating pin shafts. The support rods have a support state and a folded state. In the support state, the other end of the support rods flips upwards around the rotating pin shafts to a position perpendicular to the support rods. In the folded state, the other end of the support rods folds down to lie flat against the support rods.

The crossbars are also a pair. One of the crossbars connects the other ends of the support rods associated with the pair of first connecting blocks, while the other crossbar connects the other ends of the support rods associated with the pair of second connecting blocks.

In the support state, the two pairs of support rods form an enclosed space between them, which serves as a constraint area for the storage assembly. The storage assembly is connected to the support rods or the crossbars.

As a preferred embodiment, the frame further includes support ribs.

The support ribs are multiple and span across the pair of support rods. The ends of the support ribs are equipped with clamping components that securely fit with the pair of support rods.

As a preferred embodiment, the connecting assembly includes a pair of first traction rods, a connecting seat, and a pair of scissor rods.

The first traction rods correspond to the pair of first connecting blocks. One end of each first traction rod is inserted into the rotating connection part of its corresponding first connecting block and is rotatably connected therein. The side of the rotating connection part opposite the open side of the U-shaped structure forms a limit structure that restricts the rotation of the first traction rod.

The connecting seat is positioned between the pair of first traction rods. The other ends of the first traction rods are rotatably connected to the connecting seat. One end of the pull rod is connected to the connecting seat via a rotating component, allowing the other end of the pull rod to flip up or down around the end connected to the connecting seat.

The scissor rods are a pair and are connected in the middle in a scissor-like manner. The pair of scissor rods are positioned between the pair of support rods, with one end of each scissor rod rotatably connected to the other ends of the support rods. The other ends of the scissor rods are connected to the support rods via movable connecting components, allowing relative movement.

The movable connecting components are guide rods, with guide slots located between the ends of the pair of support rods. The other ends of the scissor rods are slidably connected to the guide slots via the guide rods.

As a preferred embodiment, the frame further includes a support fabric. The support fabric is made of a multi-layered material structure, with multiple support ribs horizontally inserted within the fabric, leaving the ends of the ribs exposed outside the support fabric.

There are two pairs of casters, corresponding respectively to the pair of first connecting blocks and the pair of second connecting blocks. The casters are attached to the first or second connecting blocks via caster mounting components.

The storage assembly can be a storage bag or storage box. The upper end of the storage bag or storage box is connected to the support frame and is used for holding items to be transported. The lower end of the storage bag or storage box can either lie flat against the frame, form a gap, or be secured with straps or U-shaped buckles attached to the support rods.

Based on the above, the disclosure also provides a camping cart that includes the aforementioned transport device. The storage assembly can be a storage bag or storage box, with its upper end connected to the support frame to hold items to be transported. The lower end of the storage assembly can either lie flat against the frame, form a gap, or be secured using straps or other fasteners.

The technical solution of this disclosure offers several advantages compared to related technologies. The design ingeniously features a support frame that can be detachably mounted on the frame, combined with a storage assembly and casters, forming a transport device that can be used as an outdoor camping cart. This setup provides a flexible and convenient way to transport items. Additionally, the frame can be in a flat, multi-board, or foldable structure. The pull rod is designed to rotate in coordination with the frame, allowing for easy extension and adjustment when in use. In its foldable form, the frame can be locked in an unfolded position with the help of constraint assemblies. When not in use, the support frame and storage assembly can be detached, and the frame can be folded up, with the pull rod also folding down, greatly reducing the space required for storage.

Moreover, the inclusion of installation components facilitates the connection of the support frame, whether it is in a detachable or foldable form, ensuring a good fit with the frame. The storage assembly can also be easily detached and installed in conjunction with the support frame, providing the transport device with flexibility, ease of storage, and structural reliability.

### BRIEF DESCRIPTION OF DRAWINGS

To more clearly illustrate the embodiments or the technical solutions in the prior art, the following is a brief introduction to the drawings used in the descriptions of the embodiments or the prior art. It is evident that the accompanying drawings described below are merely some embodiments of the present disclosure. For those skilled in the art, other drawings can be obtained based on these drawings without inventive efforts.

FIG. 1 is one of the schematic diagrams of Embodiment 1;

FIG. 2 is a brief schematic diagram of the structure of Embodiment 1 after removing the storage assembly;

FIG. 3 is a brief schematic diagram of the storage assembly connected to the support frame in Embodiment 1;

FIG. 4 is a brief schematic diagram of the principle of the constraint components on the support frame cooperating with the connection slots in Embodiment 1;

FIG. 5 is one of the schematic diagrams of Embodiment 2;

FIG. 6 is another schematic diagram of Embodiment 2;

FIG. 7 is a brief schematic diagram of the structure of Embodiment 2 after removing the storage assembly;

FIG. 8 is one of the schematic diagrams of Embodiment 2 after removing the storage assembly and support frame, showing the pull rod flipped into the frame;

FIG. 9 is another schematic diagram of Embodiment 2 after removing the storage assembly and support frame, showing the pull rod flipped into the frame;

FIG. 10 is a brief cross-sectional schematic diagram of one of the structures in Embodiment 2, showing a connection form between the guide rod, the first chassis, and the second chassis;

FIG. 11 is another brief cross-sectional schematic diagram of another structure in Embodiment 2, showing another connection form between the guide rod, the first chassis, and the second chassis;

FIG. 12 is a schematic diagram of the support frame in Embodiment 3;

FIG. 13 is one of the schematic diagrams showing the cooperation between the frame and the pull rod in Embodiment 4, showing the frame in the expanded and locked state;

FIG. 14 is another schematic diagram showing the cooperation between the frame and the pull rod in Embodiment 4, showing the frame in the folding process;

FIG. 15 is another schematic diagram showing the cooperation between the frame and the pull rod in Embodiment 4, showing the frame in the folded state;

FIG. 16 is a partial schematic diagram of the brief structure of the pull rod in Embodiment 4;

FIG. 17 is one of the schematic diagrams showing the cooperation between the frame and the pull rod in Embodiment 5, showing the frame in the expanded and locked state;

FIG. 18 is another schematic diagram showing the cooperation between the frame and the pull rod in Embodiment 5, showing the frame in the folding process;

FIG. 19 is another schematic diagram showing the cooperation between the frame and the pull rod in Embodiment 5, showing the frame in the folded state;

FIG. 20 is a schematic diagram of the principle of cooperation between the constraint assembly and the connection assembly in Embodiment 5, with FIG. 20(a) showing one example of the cooperation and FIG. 20(b) showing another example;

FIG. 21 is one of the schematic diagrams showing the cooperation between the frame and the pull rod in Embodiment 6, showing the frame in the expanded and locked state;

FIG. 22 is a brief schematic diagram of the structure and partial local structure of Embodiment 7;

FIG. 23 is one of the schematic diagrams showing the cooperation of the frame, support frame, installation assembly, pull rod, and casters in the transport device of Embodiment 7;

FIG. 24 is another schematic diagram showing the cooperation of the frame, support frame, installation assembly, pull rod, and casters in the transport device of Embodiment 7;

FIG. 25 is another schematic diagram showing the cooperation of the frame, support frame, installation assembly, pull rod, and casters in the transport device of Embodiment 7;

FIG. 26 is a schematic diagram showing the cooperation between the support ribs and the support fabric in the transport device of Embodiment 7;

FIG. 27 is a schematic diagram showing the cooperation between the support frame and the storage assembly in the transport device of Embodiment 7;

FIG. 28 is a brief schematic diagram of one of the structures of the installation sleeve in the transport device of Embodiment 7;

FIG. 29 is a brief schematic diagram of one of the structures of the first connecting block or second connecting block in the transport device of Embodiment 7;

FIG. 30 is a brief schematic diagram of one of the structures of the locking member in the transport device of Embodiment 7;

FIG. 31 is a brief schematic diagram of another structure of the installation sleeve in the transport device of Embodiment 7;

FIG. 32 is a brief schematic diagram of another structure of the first connecting block or second connecting block in the transport device of Embodiment 7;

FIG. 33 is one of the schematic diagrams showing the cooperation of the frame, support frame, installation assembly, pull rod, and casters in the transport device of Embodiment 8, with the support rods in the support state;

FIG. 34 is another schematic diagram showing the cooperation of the frame, support frame, installation assembly, pull rod, and casters in the transport device of Embodiment 8, with the crossbars retracted;

FIG. 35 is another schematic diagram showing the cooperation of the frame, support frame, installation assembly, pull rod, and casters in the transport device of Embodiment 8, with both the support rods and crossbars retracted.

### DETAILED DESCRIPTION OF THE INVENTION

To further clarify the embodiments of the present disclosure and the technical solutions in the prior art, a detailed description is provided below in conjunction with the accompanying drawings. It is specifically noted that the following embodiments are only for illustrating the present disclosure and do not limit its scope. Similarly, the following embodiments are just a part of all the embodiments of the present disclosure. Any other embodiments obtained by those skilled in the art without making inventive efforts are within the scope of the present disclosure.

### Embodiment 1

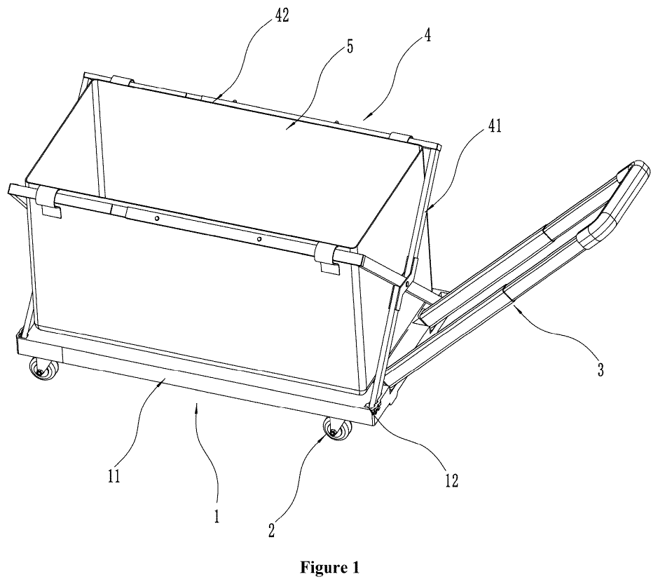

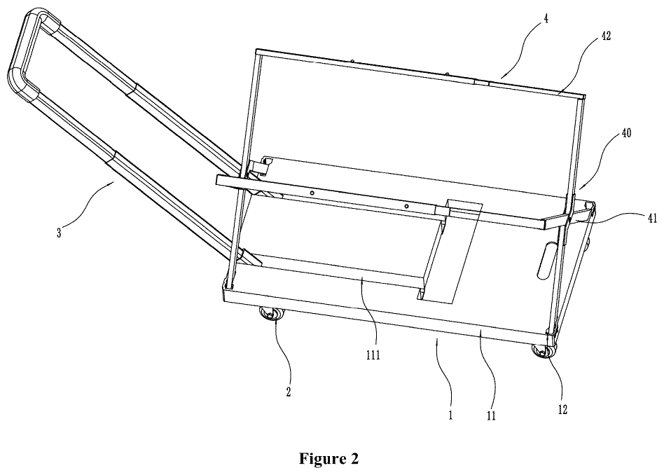

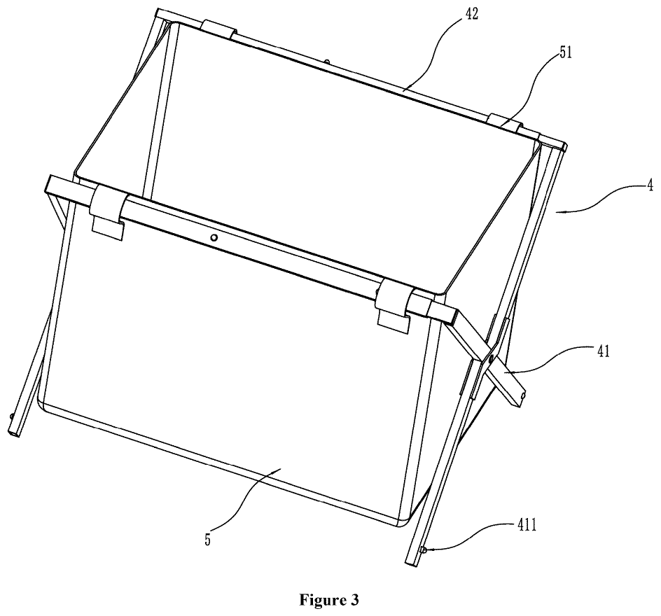

As shown in FIGS. 1 to 4, this embodiment discloses a transport device, which includes a frame 1, casters 2, a pull rod 3, a support frame 4, and a storage assembly 5.

The casters 2 are mounted at the lower part of the frame 1.

The pull rod 3 is connected to one end of the frame 1 and is used for moving the frame 1.

The support frame 4 is detachably connected to the upper end of the frame 1. The storage assembly 5 is mounted on the frame 1.

The storage assembly 5 is connected to the support frame 4 and is used to accommodate items to be transported.

To facilitate the fixing of the support frame 4 and easy disassembly during storage, the upper ends of both sides of the frame 1 are provided with connecting slots 12 corresponding to the support frame 4. The lower end of the support frame 4 can be detachably inserted into the connecting slot 12. The connecting slot 12 is provided with a constraint hole 121. The lower end of the support frame 4 is provided with a constraint component 4111 corresponding to and engaging with the constraint hole 121. The constraint component 4111 and the constraint hole 121 have a locked state and an unlocked state. Specifically, in this embodiment, the support frame 4 includes a first connecting frame 40 and a second connecting rod 42.

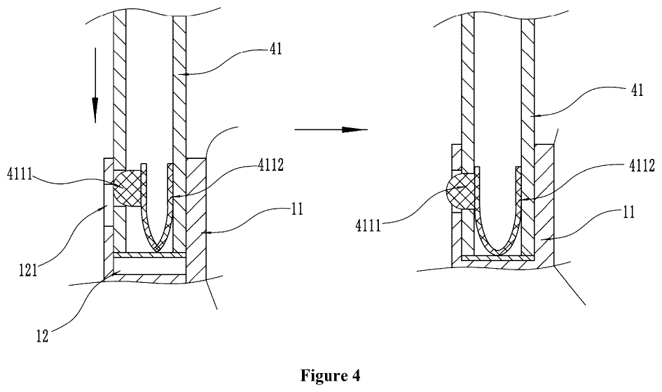

The first connecting frame 40 consists of a pair of structures set oppositely on both sides of the upper end of the frame 1. The first connecting frame 40 includes a pair of first connecting rods 41 that are scissor-like pivotally connected. The lower ends of the pair of first connecting rods 41 correspond to the connecting slots 12 on the frame 1. The constraint component 4111 is provided at the lower end of the first connecting rod 41. The lower end of the first connecting rod 41 can be detachably connected in the connecting slot 12 through the constraint component 4111, and engage with the constraint hole 121. As highlighted in FIG. 4, in this embodiment, the first connecting rod 41 may have a hollow structure. Inside the connecting rod 41, there is an elastic piece 4112 that matches the constraint component 4111. In this structure, when the first connecting rod 41 is inserted into the connecting slot 12, the constraint component 4111 is compressed and retracted into the first connecting rod 41. When the constraint component 4111 aligns with the constraint hole 121, the elastic piece 4112 ejects it, causing the constraint component 4111 to engage with the constraint hole 121, thus locking the support frame 4 to the frame 1.

The second connecting rod 42 consists of a pair and is arranged parallelly between the pair of first connecting frames 40. The ends of the second connecting rods 42 are fixedly connected to the upper ends of the pair of first connecting rods 41 of the first connecting frames 40.

In the structural implementation of this embodiment, the constraint component 4111 and the constraint hole 121 have a locked state and an unlocked state.

In the locked state, the constraint component 4111 enters the constraint hole 121, thereby securing the lower end of the support frame 4 within the connecting slot 12.

In the unlocked state, the constraint component 4111 disengages from the constraint hole 121, allowing the lower end of the support frame 4 to be removed from the connecting slot 12.

The storage assembly 5 includes a storage space for accommodating items to be transported. The upper end of the storage assembly 5 is detachably connected to the upper ends of the pair of support frames 4. The lower end of the storage assembly 5 extends downward toward the frame 1.

Additionally, when the constraint component 4111 is in the locked state with the constraint hole 121, it secures the first connecting rod 41 in the constraint hole 121. Along with the weight of the storage assembly 5 and the items placed inside, this configuration provides high structural stability for the transport device.

For disassembly, when the constraint component 4111 is in the unlocked state with the constraint hole 121, it allows the first connecting rod 41 to be removed from the connecting slot 121. In this embodiment, the elastic piece 4112 can deform under the force exerted on the constraint component 4111, causing it to retract, allowing the user to pull out the first connecting rod 41 for disassembly.

Regarding the structure of the frame 1, this embodiment includes a chassis 11.

The chassis 11 has a rectangular plate structure. The casters 2 are positioned at the corners of the lower surface of the chassis 1. The connecting slots 121 are arranged on both sides of the upper end of the chassis 1 in an opposing configuration.

The chassis 11 is equipped with a storage slot 111 for accommodating the pull rod 3. One end of the storage slot 111 extends to one end of the chassis 1. The pull rod 3 is pivotally connected at one end to the storage slot 111.

In this embodiment, the pull rod 3 can be either telescopic or non-telescopic.

The storage assembly 5 in this embodiment can be a storage bag or a storage box. The upper end of the storage assembly 5 can be connected to the support frame 4 through a connecting strap 51 and is used to hold items to be transported. The lower end of the storage assembly 5 can be attached to the frame 1, leave a gap, or be connected via a binding element. When the storage assembly 5 is detachably bound to the frame 1 with a binding element, it is not necessary to provide a constraint hole 121 in the connecting slot 121, nor does the lower end of the first connecting rod 41 need to be equipped with a constraint component 4111. In this case, the binding force of the binding element with the frame 1, combined with the weight of the items in the storage assembly 5, can securely connect the support frame 4 to the frame 1.

### Embodiment 2

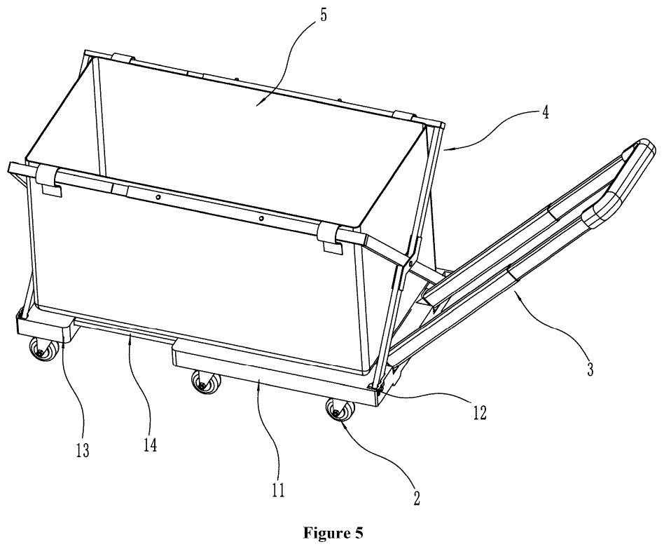

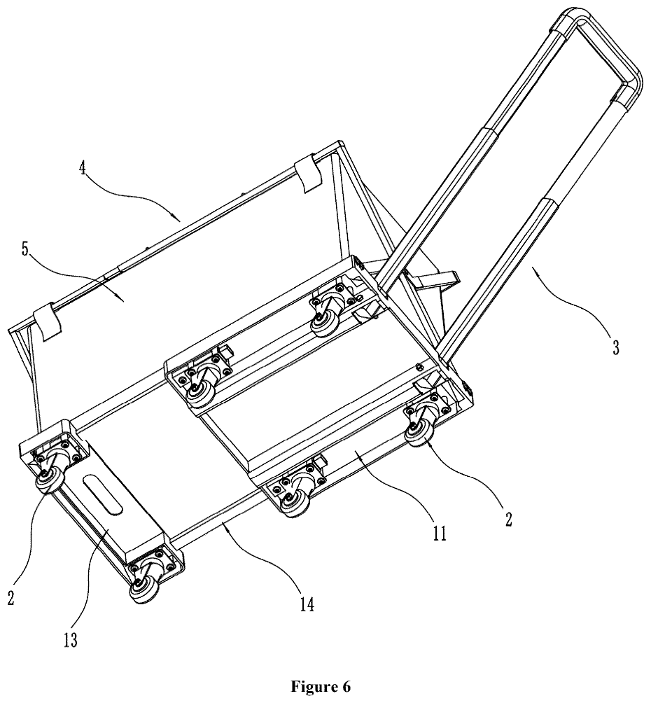

As shown in FIGS. 5 to 10, this embodiment is generally similar to Example 1. The difference lies in the structure of the frame 1, which differs from that in Example 1. Specifically, in this embodiment, the frame includes a first chassis 11, a second chassis 13, and guide rods 14.

The first chassis 11 has a rectangular plate structure. The storage slot is set on the first chassis 11. The casters 2 are located at the corners of the lower surface of the first chassis 11.

The second chassis 13 also has a rectangular plate structure. A pair of casters 2 is set on both sides of the lower end of the second chassis 13.

The guide rods 14 are arranged in pairs and positioned parallel and opposite to each other. One end of each guide rod 14 is connected to the end of the second chassis 13 near the first chassis 11. The first chassis 11 is equipped with guide slots 112 corresponding to the pair of guide rods 14. The other end of each guide rod 14 can slide into the guide slots 112. The guide slots 112 are equipped with removable locking members 113. Multiple locking holes 141 are set at intervals along the length of the guide rods 14 to interact with the locking members 113. As an example, the locking holes 141 can be screw holes, and the locking members 113 can be screws. The locking members 113 and the locking holes 141 can achieve a fixed constraint state or a release state.

In the fixed constraint state, the locking members 113 pass through the guide slots 112 and connect with one of the locking holes 141, securing the guide rods 14 within the guide slots 112.

In the release state, the locking members 113 disengage from the locking holes 141, allowing the guide rods 14 to slide relative to the guide slots 112.

In this structural configuration, the connecting slots 12 used to secure the support frame 4 are positioned on opposite ends of the first chassis 11 and the second chassis 13.

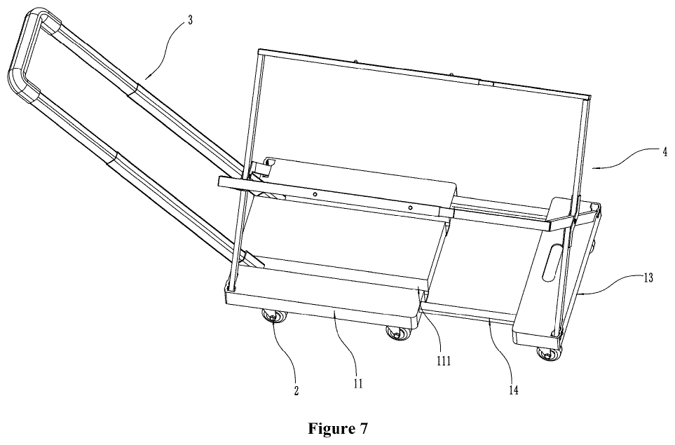

In this embodiment, the first chassis 11 and the second chassis 13 can adjust the length of the guide rods 14 based on the length or volume of the transported items, thereby altering the supportive length of the frame 1. This design enhances the flexibility of the device's use. When not in use, the storage assembly 5 (as shown in FIG. 7) and the support frame 4 can be detached, the handle rod 3 can be flipped into the storage slot 111, and the guide rods 14 can be retracted into the guide slots 112, bringing the second chassis 13 closer to the first chassis 11 to complete the folding and storage of the transport device.

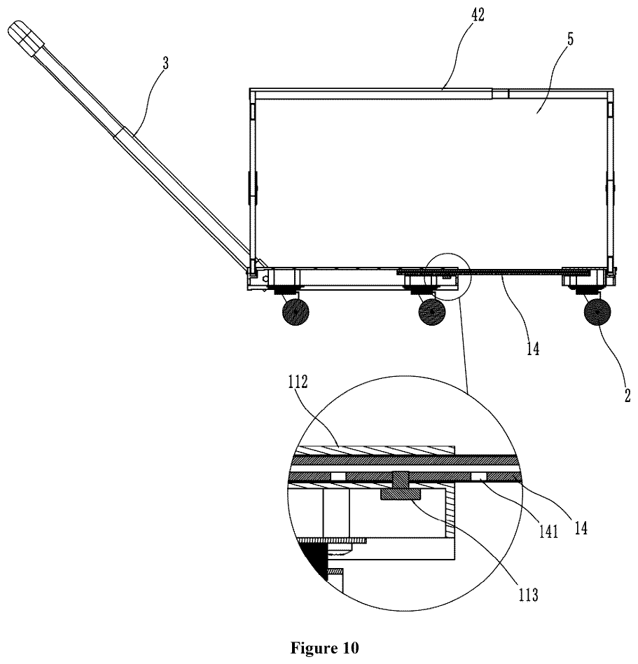

Apart from the connection form between the guide rods 14 and the first chassis 11 and the second chassis 13 shown in FIG. 10, another possible alternative is illustrated in FIG. 11. The bottom of the second chassis 13, corresponding to one end of the guide rods 14, is equipped with a connecting part 131. The connecting part 131 houses fixing elements 143 (such as bolts) that fit securely with the guide rods 14. Specifically, the fixing elements 143 pass through the connecting part 131 and lock into the locking holes on the guide rods 14. The end of the guide rods 14 inserted into the guide slots 112 is equipped with a retaining part 142 to prevent the guide rods 14 from slipping out of the guide slots 112. In this structural configuration, the second chassis 13 can be separated from the guide rods 14 by disengaging the fixing elements 143, allowing the second chassis 13 to be directly attached to the bottom of longer items, thus enabling the transport of goods that exceed the length of the frame. When the length of the goods is within the adjustable range of the first chassis 11 and the second chassis 13, the weight of the heavy items, combined with appropriate strapping, can indirectly fix the first chassis 11 and the second chassis 13 relative to each other.

### Embodiment 3

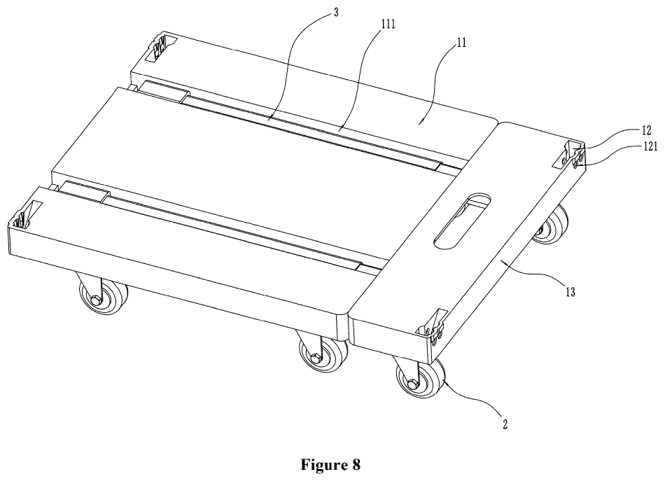

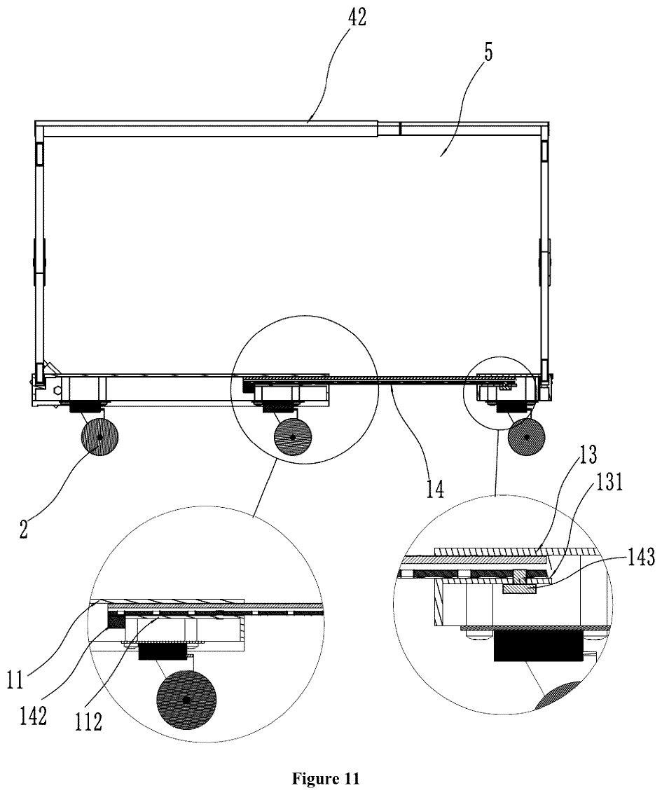

As illustrated in FIGS. 8 and 12, this embodiment primarily proposes an alternative structure for the support frame 4, as exemplified in Embodiments 1 and 2. In this embodiment, the support frame 4 includes support rods 43 and second connecting frames 44.

The support rods 43 are arranged in pairs, positioned oppositely on both sides of the upper end of the frame 1. The lower ends of the support rods 43 are detachably inserted into the connecting slots 12 of the frame 1. The constraint components 431 are located at the lower ends of the support rods 43, and these ends are detachably connected to the connecting slots 12 through the constraint components 431. The structure of the constraint components 431 can be consistent with those mentioned in Embodiments 1 and 2.

The second connecting frames 44 are also arranged in pairs, positioned oppositely between adjacent support rods 43. Each second connecting frame 44 consists of a pair of scissor-like pivotally connected second connecting rods. The upper ends of each pair of second connecting rods are pivotally connected to the adjacent support rods 43 (e.g., through a pivot seat 432 connected to the upper end of support rods 42). The lower ends of each pair of second connecting rods are slidably connected to the midsection of the adjacent support rods 43 via sliding elements 433. Furthermore, the second connecting rods are pivotally connected to the sliding elements 433.

Similar to the method of fixing the support frame 4 in Embodiments 1 and 2, in this embodiment, when the constraint components 431 are in the locked state with the constraint holes 121, the constraint components 43 insert into the constraint holes 121 to secure the lower ends of the support rods 43 in the connecting slots 12.

When the constraint components 431 are in the unlocked state with the constraint holes 121, the constraint components 431 disengage from the constraint holes, allowing the support rods 43 to be removed from the connecting slots 12.

### Embodiment 4

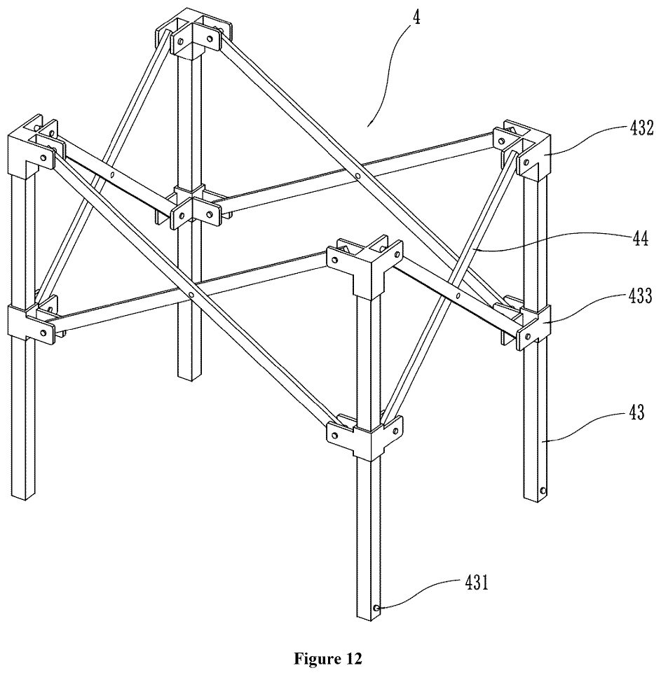

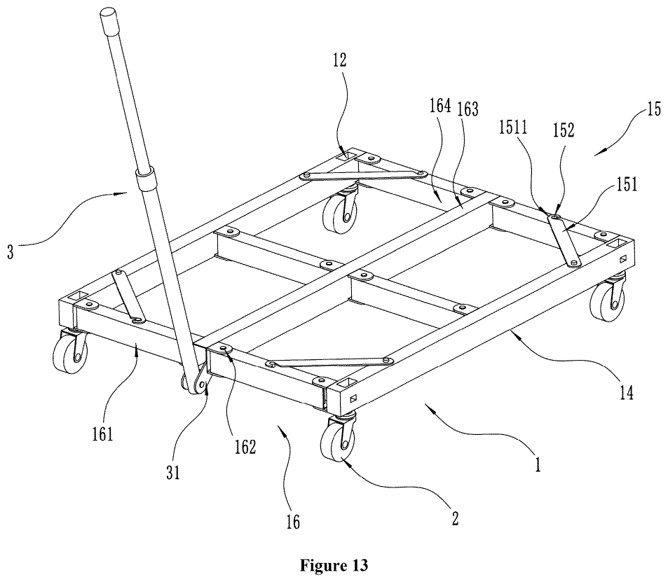

As shown in FIGS. 13 to 16, this embodiment proposes a structure for the frame 1 that can be folded or expanded along its width, providing an alternative to the frames described in Embodiments 1 and 2. The frame 1 in this embodiment includes a pair of support rods 14, a connecting assembly 16, and a constraint assembly 15.

The pair of support rods 14 extend horizontally and are arranged in parallel. The casters 2 are attached to the lower ends of the support rods 14. The connecting slots 12 are located at the ends of the support rods 14.

The connecting assembly 16 connects to each of the support rods 14 and can move them, allowing the frame 1 to fold or expand in the width direction.

The constraint assembly 15 interacts with the pair of support rods 14 and the connecting assembly 16, enabling the frame 1 to maintain a locked state when expanded or to unlock for folding in the width direction.

Specifically, in this embodiment, the connecting assembly 16 includes a pair of first traction rods 161, connecting seats 162, a second traction rod 163, and two pairs of third traction rods 164.

Each of the first traction rods 161 corresponds to one of the support rods 14, with one end pivotally connected to the end of the respective support rod 14.

The connecting seats 162 are located between the pair of first traction rods 161. The other ends of the first traction rods 161 are pivotally connected to the connecting seats 162.

The second traction rod 163 is positioned between the pair of support rods 14 and runs parallel to them. One end of the second traction rod 163 extends between the pair of first traction rods 161. There are two connecting seats 162, each located on opposite sides of one end of the second traction rod 163. Each connecting seat 162 is pivotally connected to the other end of a first traction rod 161.

There are two pairs of third traction rods 164, each pair arranged oppositely at the other end and the middle of the second traction rod 163. One end of each third traction rod 164 is pivotally connected to the second traction rod 163, while the other end is pivotally connected to the adjacent support rod 14 (i.e., the support rod 14 on the same side as the second traction rod 163).

Based on this structure, the constraint assembly 15 in this embodiment includes connecting columns 152 and constraintrods 151.

The connecting columns 152 are at least a pair and are oppositely connected between the ends of the support rods 14 on the first traction rod 161 and the third traction rod 164.

The constraintrods 151 are also at least a pair, oppositely connected to the ends of the support rods 14. One end of each constraintrod 151 is pivotally connected to an end of a support rod 14, while the other end has a connecting hook 1511. This hook is designed to detachably engage with the connecting columns 152 located on either the first traction rod 161 or the third traction rod 164, enabling the frame 1 to maintain a locked expanded state or to unlock for folding in the width direction.

In this embodiment, although the described implementation mainly features the connecting columns 152 on both the first traction rod 161 and the third traction rod 164, the columns can alternatively be positioned only on one of these rods. Correspondingly, the constraintrods 151 would connect to either end of the support rods 14. However, this single-sided setup may compromise the structural integrity of the locked state. Thus, a preferred configuration includes two pairs of constraintrods 151 and connecting columns 152, as shown in FIGS. 13 and 14, to enhance stability.

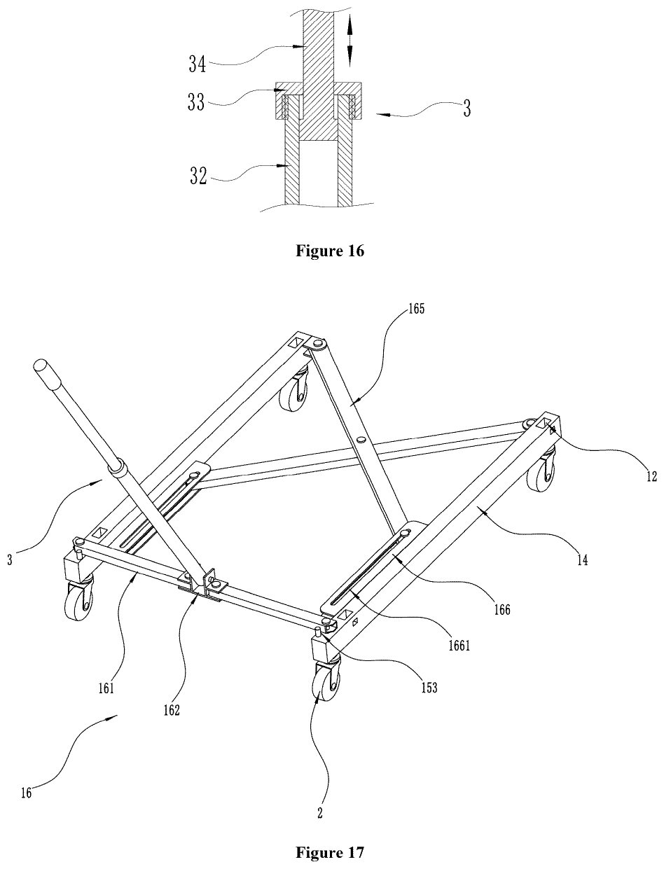

Referring to FIG. 16, to enhance the usability and compactness of the pull rod when the transport device is stored, the pull rod 3 is designed as a split structure. The pull rod 3 includes a first traction rod 32 and a second traction rod 34. One end of the first traction rod 32 is pivotally connected to the connecting seat 162 via a rotating member 31, specifically at the end of the second traction rod 163 located between the pair of first traction rods 161. The second traction rod 34 is slidably connected in parallel to the other end of the first traction rod 32, and features an anti-detachment structure 33 that prevents separation between the first and second traction rods. The second traction rod 34 can pivot up or down around the end of the first traction rod 32 that is pivotally connected to the connecting seat 162. The length of the first and second traction rods can be chosen such that the second traction rod 34 is relatively shorter, allowing the user to adjust the position and angle of the second traction rod 34 for easier handling of the transport device, leveraging the rotational connection of the first traction rod 32 to the connecting seat 162.

In this embodiment, the connecting seat 162 can also be designed as a single integrated structure, directly connected to the end of the second traction rod 163, with the pair of first traction rods 161 pivotally connected to the connecting seat 162.

Regarding the choice of wheels, this embodiment uses universal wheels for the wheels 2. Alternatively, some or all of the wheels can be unidirectional.

Additionally, aside from the split structure design mentioned for the pull rod 3, this plan also allows for the pull rod to be a single integrated rod structure. In the case of a single rod structure, one end of the pull rod 3 is connected to the connecting seat 162 via a rotating component 31, and the other end can pivot up or down around the end of the pull rod connected to the connecting seat.

Referring to FIG. 13, when using this embodiment of the transport device, the pull rod 3 can first be flipped out, then the second traction rod 34 is pulled towards the user's subsequent hand-pulling position and direction. The support rods 14 are then pulled to unfold the frame. During unfolding, the rotational connections between the first traction rod 161, the second traction rod 163, and the third traction rod 164 make it easier to expand the frame when pulling the support rods 14. After expansion, the constraintrods 151 of the constraint assembly 15 are rotated, allowing their connecting hooks 1511 to detachably engage with the corresponding connecting columns 152, thereby locking the expanded state of the frame 1. The constraintrods 151 can be made from metal sheets or thin plastic sheets, utilizing their ability to deform within a certain thickness to ensure a tight fit between the connecting hooks 1511 and the connecting columns 152 when hooked. Disengagement (or unlocking) is facilitated by applying a certain force. In this embodiment, once the frame 1 is expanded, the area above the support rods 14 forms a support zone for placing items. The user can then install the support frame on the frame 1, followed by the installation of the storage assembly, and finally place packed items in boxes, cases, or bags into the storage assembly above the frame 1.

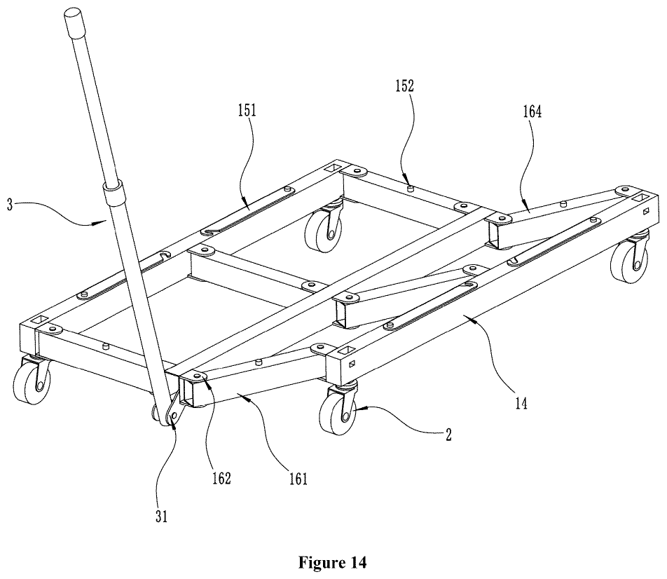

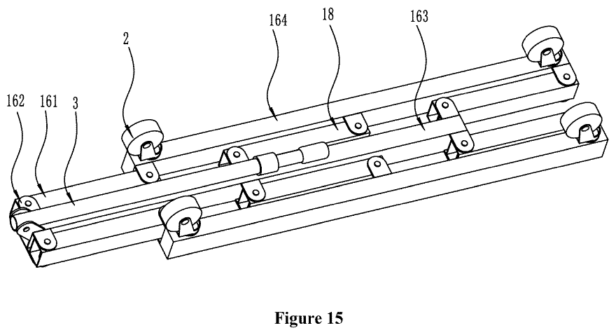

As shown in FIGS. 13 to 15, when the transport device is not in use, the support frame and storage assembly can be removed. The frame's expanded lock can then be released by disengaging the constraintrods 151 of the constraint assembly 15 from the connecting columns 152, as illustrated in FIG. 13. The frame is folded from the width direction of the frame 1 by collapsing the support rods 14 from both sides of the frame 1. Finally, the pull rod 3 is folded (as shown in FIG. 15), completing the folding of the transport device.

### Embodiment 5

As shown in FIGS. 17 to 20, this embodiment is largely similar to Embodiment 4 and aims to provide an alternative design for the frame 1. Unlike Embodiment 4, this embodiment features a different connecting assembly 16 for the frame 1. In this embodiment, the pair of support rods 14 of the frame 1 are arranged horizontally parallel to each other, and the connecting assembly 16 includes a pair of first traction rods 161, connecting seats 162, a pair of third traction rods 165, and sliding guide members 166.

The first traction rods 161 are paired, with each one corresponding to one of the support rods 14. One end of each first traction rod 161 is pivotally connected to one end of the support rod 14.

The connecting seats 162 are positioned between the pair of first traction rods 161. The opposite ends of the first traction rods 161 are pivotally connected to opposite sides of the connecting seats 162.

The third traction rods 165 are also paired and are pivotally connected in the middle via a pivoting axle 1651. These third traction rods 165 are positioned between the support rods 14, with one end of each third traction rod 165 pivotally connected to the opposite end of the support rods 14.

The number of sliding guide members 166 corresponds to the number of support rods 14, and they are fixed between the ends of the support rods 14. Each third traction rod 165 has its opposite end connected to the sliding guide members 166 through sliding connectors 1652, allowing relative movement of the frame 1 during folding or unfolding. Specifically, the sliding guide members 166 are equipped with slots 1661, and the sliding connectors 1652 engage with these slots.

In this embodiment, when the coupling between the constraint assembly 14 and the connecting assembly 16 is in the unlocked state and the pair of support rods 14 of the frame 1 move towards or away from each other, the opposite ends of the third traction rods 165 move relative to the support rods 14, enabling the frame to fold or unfold along the width direction.

The constraint assembly 15 in this embodiment features rod-like limiters 153, each corresponding to one of the support rods 14. These limiters 153 are fixed at one end of the support rods 14 and are designed to limit the rotation of the opposite end of the first traction rods 161 away from the other end of the support rods 14 to a predetermined angle (in this embodiment, the limit is set to allow the first traction rods 161 to rotate up to 90 degrees±15 degrees relative to the support rods 14). When the opposite end of the first traction rods 161 rotates away from the other end of the support rods, it contacts the limiters 153, locking the frame 11 in the expanded state in one direction. This design ensures that the frame 11 remains expanded under the pulling force applied by the user via the pull rod 3, preventing unintended folding of the support rods 14 when the pull rod 3 is not in use. Additionally, since this transport device is primarily used on flat surfaces, the support rods 14 will not fold on their own without pulling force.

To avoid interference between the limiters 153 and the first traction rods 161 when folding the frame 1, the first traction rods 161 and the limiters 153 have the following configurations or positional relationships:

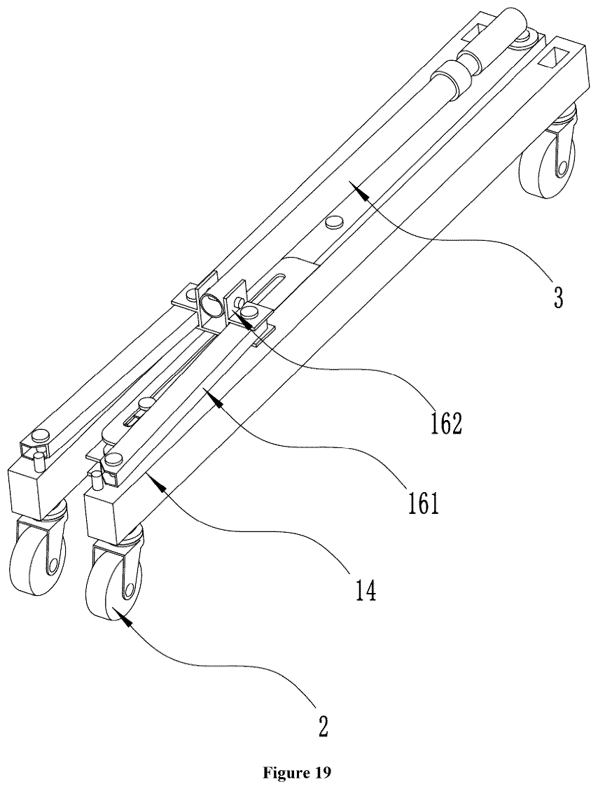

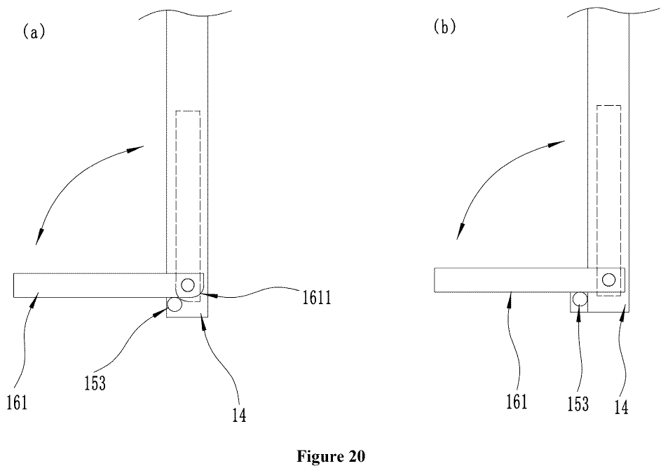

As shown in FIG. 20(a), the section of the first traction rod 161 near the limiter 153 is designed with a clearance structure 1611. This clearance structure 1611 allows the opposite end of the first traction rod 161 to rotate towards the other end of the support rod 1 without causing mechanical interference with the limiter 153.

As shown in FIG. 20(b), a predetermined gap is maintained between one end of the first traction rod 161 and the limiter 153. This design ensures that when the opposite end of the first traction rod 161 rotates towards the other end of the support rod 14, its virtual movement trajectory does not overlap with the position of the limiter 153. Conversely, when the opposite end of the first traction rod 161 rotates away from the support rod 14, the limiter 153 is positioned within the virtual movement trajectory of the first traction rod 161, allowing the pull rod 3 to lock (or limit) the movement once the first traction rod 161 reaches a predetermined angle.

In this embodiment, one end of the pull rod 3 is connected to the connecting seat 162 through a pivoting component (such as a rotating pin or axle), and the other end of the pull rod 3 can pivot upwards or downwards around the end connected to the connecting seat 162. The structure of the pull rod 3 can either be a single-piece design or a dual-piece design, similar to that described in Embodiment 4, and will not be further detailed here.

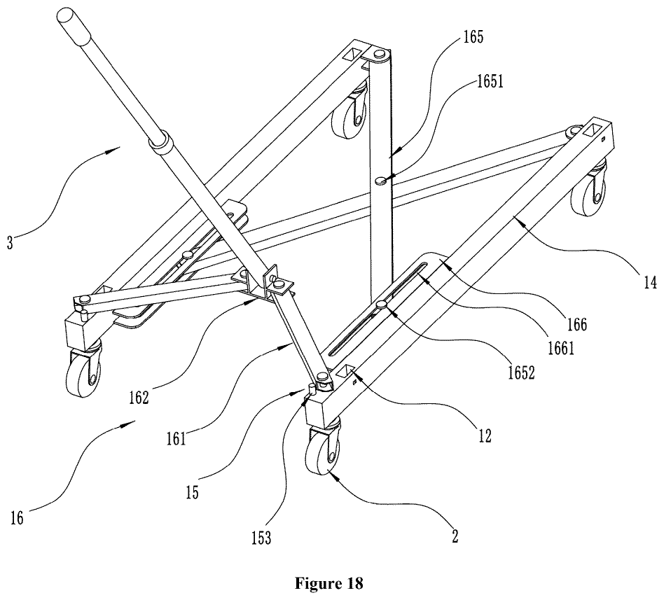

As illustrated in FIGS. 17 to 19, when the transport device is not in use, the frame I can be folded by pushing the pull rod 3 in the opposite direction, causing the pair of first traction rods 161 to rotate towards the opposite end of the support rods 14. This action disengages the limiters 153 of the constraint assembly 4 from the first traction rods 161. Since the transport device is not being used, the user stops applying pulling force to the pull rod 3, allowing the first traction rods 161 to rest against the limiters 153. By further pushing the pull rod 3 backward, the first traction rods 161 rotate towards the opposite end of the support rods 14, thereby automatically releasing the frame 1 from its locked state (as shown in FIG. 18). Once the pair of support rods 14 and the connecting assembly are fully folded, the pull rod 3 can be folded and flipped, as shown in FIG. 19, completing the folding of the transport device.

### Embodiment 6

As shown in FIG. 21, this embodiment is largely similar to Embodiment 5, aiming to provide an alternative design for the frame 1. The difference from Embodiment 5 lies in the use of connecting sleeves 17 instead of the sliding guide elements described in Embodiment 5. In this embodiment, the number of connecting sleeves 17 corresponds to the number of pairs of support rods 41. The connecting sleeves 17 are slidably mounted along the length of the support rods 14. The other ends of the pair of third connecting rods 1651 are pivotally connected to the pair of connecting sleeves 17 through rotating connectors. Thus, in this embodiment, the connecting sleeves 17 replace the sliding guide elements, and it should be noted that the length direction of the support rods 14 is parallel to the moving direction of the transport device.

Since the principle of use and folding of the transport device in this embodiment is roughly the same as in Embodiment 5, a detailed explanation is omitted. Additionally, the same reference parts that are not explicitly mentioned in this embodiment are substantially the same as those in Embodiment 5 and are not elaborated upon here.

### Embodiment 7

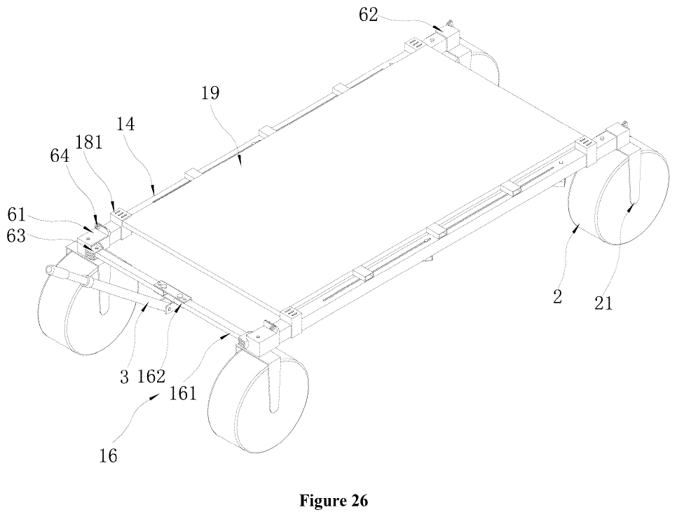

As illustrated in FIGS. 22 to 32, this embodiment describes a transport device, including a frame 1, wheels 2, and a pull rod 3.

The wheels 2 are mounted on the lower part of the frame 1. The pull rod 3 is connected to one end of the frame 1 and is used for moving the frame 1.

The transport device further includes an installation assembly 6, a support frame 4, and a storage assembly 5.

The installation assembly 6 is mounted on the frame 1.

The support frame 4 is connected to the installation assembly 6 on the frame 1.

The storage assembly 5 is set on the frame 1 and is connected to the support frame 4 for accommodating items to be transported.

Specifically, as shown in FIGS. 22 to 26, the frame 1 includes support rods 14 and a connecting assembly 16.

The support rods 14 are arranged in pairs and horizontally opposite each other. The wheels 2 are connected to the lower ends of the support rods 14.

The connecting assembly 16 is connected to the pair of support rods 14, providing lateral support and allowing the pair of support rods 14 to move, enabling the frame 1 to fold or unfold along the width direction.

The connecting assembly 16 is also connected to the installation assembly 6, which includes a limit structure 631 to restrict the extent to which the frame 1 can unfold widthwise.

In this design, the support frame 4 and storage assembly 5 can be arranged for folding or disassembly, facilitating easy storage when the transport device is not in use. Preferably, the installation assembly 6 includes a pair of first connecting blocks 61 and second connecting blocks 62.

The first connecting blocks 61 are paired and correspond to the pair of support rods 14. One end of the first connecting blocks 61 has a slot and fits with one end of the support rods 14. A U-shaped rotating connection part 63 is located on the opposite side of each pair of first connecting blocks 61.

The second connecting blocks 62 are also paired and correspond to the pair of support rods 14. One end of the second connecting blocks 62 has a slot that fits with the other end of the support rods 14.

The connecting assembly 16 is rotatably connected to the rotating connection parts 63 of the first connecting blocks 61. The closed side of the rotating connection part 63, opposite the U-shaped opening, forms a limit structure 631, which restricts the rotational engagement between the connecting assembly 16 and the rotating connection part 63.

The support frame 4 is connected to the upper ends of the first connecting blocks 61 and the second connecting blocks 62.

In one embodiment of the support frame 4 design, the support frame 4 is detachably connected to the upper ends of the pair of first connecting blocks 61 and the pair of second connecting blocks 62 using a fitting component. Each of the first connecting blocks 61 and the second connecting blocks 62 has a tab 64 on its upper end for engaging with the fitting component. The tab 64 and the upper surface of the first or second connecting blocks 61, 62 form a constraint area. The fitting component is inserted into the constraint area and detachably engages with the tab 64.

This structure allows for the removal of the support frame 4 and storage assembly 5 when not in use, by detaching the support frame 4. For storage, the frame 1 can be folded, or the device can be used directly to transport goods placed on the frame 1.

As a preferred example of the structural design, the support frame 4 includes a pair of first connecting frames 40 and a pair of second connecting rods 42.

The first connecting frames 40 are arranged opposite each other at the ends of the pair of support rods 14 on the frame 1. Each first connecting frame 40 includes a pair of first connecting rods 41, which are pivotally connected in a scissor-like manner. The lower ends of the first connecting rods 41 of one first connecting frame 40 are detachably connected to the upper ends of the first connecting blocks 61 using fitting components, engaging with the tabs 64. The lower ends of the first connecting rods 41 of the other first connecting frame 40 are similarly connected to the second connecting blocks 62.

The second connecting rods 42 are also arranged in pairs, parallel to each other, between the pair of first connecting frames 40. Each end of the second connecting rods 42 is fixedly connected to the upper ends of the first connecting rods 41 in the first connecting frames 40.

The pair of second connecting rods 42 and the pair of first connecting frames 40 form an enclosed space for accommodating the storage assembly 5. The storage assembly 5 is connected to the pair of second connecting rods 42.

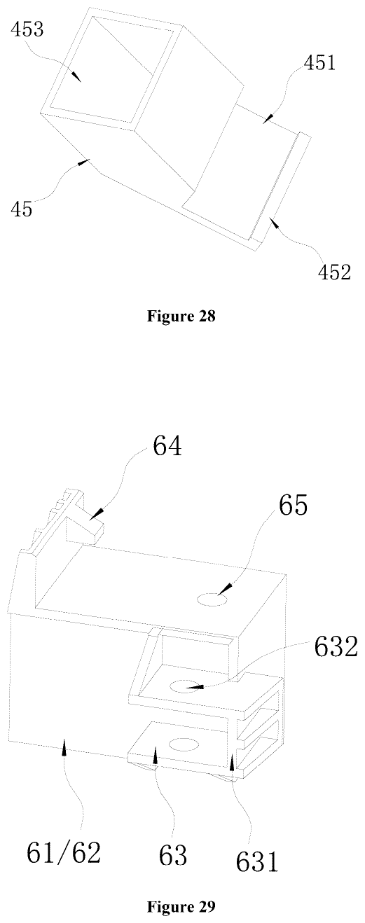

To facilitate the connection between the first connecting rod 41 and the first connecting block 61 or the second connecting block 62, a preferred implementation includes the use of an installation sleeve 45, as highlighted in FIGS. 28 and 29.

The installation sleeve 45 is a tubular housing structure that matches the end of the first connecting rod 41. The end of the first connecting rod 41 is inserted into the tubular housing of the installation sleeve 45, which features a slot 453 for the first connecting rod 41 to pass through. The installation sleeve 45 has an extension part 451 designed to be inserted into the constraint area and engage detachably with the tab 64. The end of the extension part 451 is further equipped with an upwardly bent section 452. This bent section 452 cooperates with the tab 64 to prevent the installation sleeve 45 from being removed from the constraint area in a first direction. The first direction is perpendicular to or at an angle to the direction in which the extension part 451 is inserted into the constraint area. For example, as shown in the enlarged view in FIG. 1, the extension part 451 of the installation sleeve 45 locks into the constraint area formed by the tab 64 and the upper surface of the first connecting block 61 or second connecting block 62. Since the first connecting rod 41 is structured in a scissor-like manner, if force is applied, it might push the extension part 451 of the installation sleeve 45 in the width direction of the frame 1. However, the tab 64 serves to restrict the extension part 451 from disengaging. Additionally, when the storage assembly 5 contains items, the increased contact friction between the support frame 4 and the frame 1 further prevents the installation sleeve 45 from being dislodged from the constraint area formed by the tab 64.

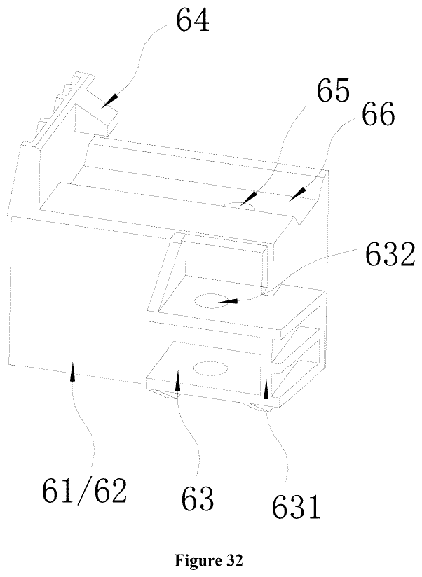

To enhance the case of fitting between the first connecting block 61 or the second connecting block 62 and the installation sleeve 45, as shown in FIGS. 31 and 32, a more preferred implementation includes the provision of a guide groove 66 on the upper end surface of the first connecting block 61 or the second connecting block 62. This guide groove 66 directs the extension part 451 into the constraint area. The lower end surface of the extension part 451 features a guiding protrusion 4511 that corresponds with the guide groove 66.

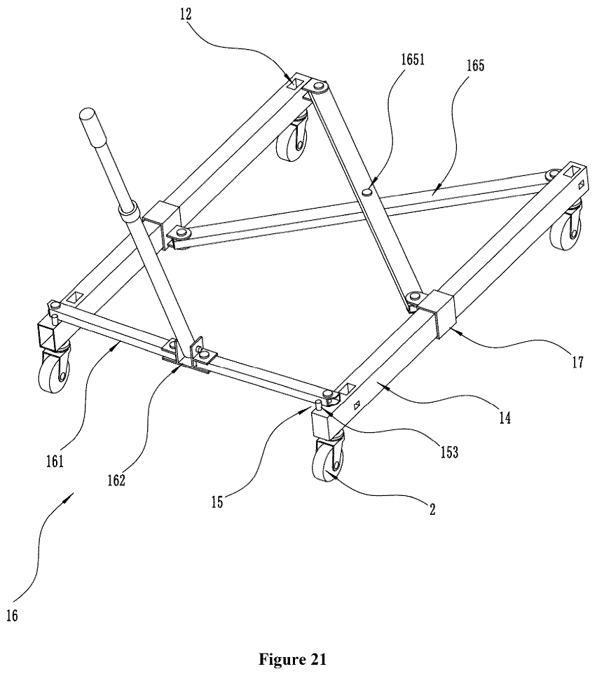

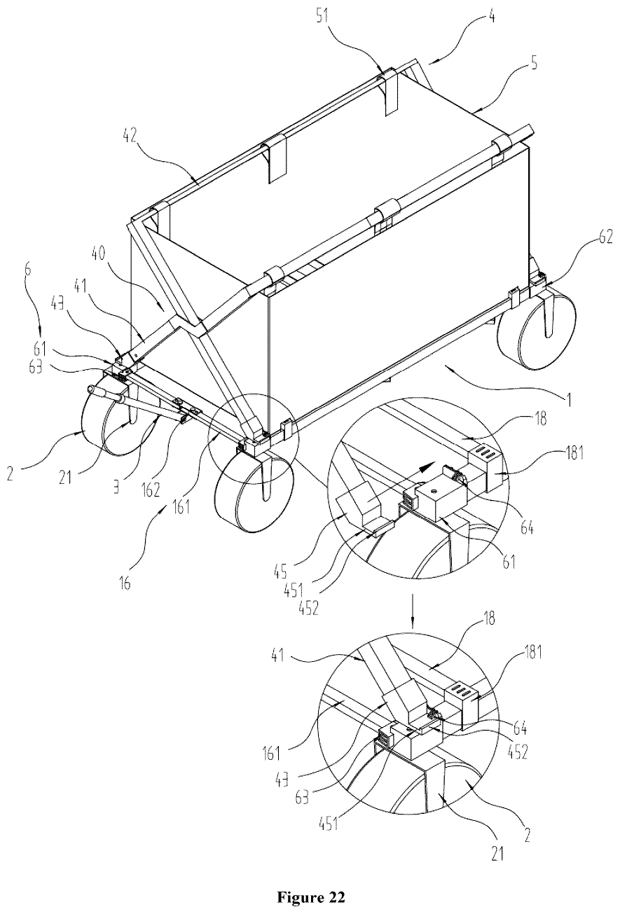

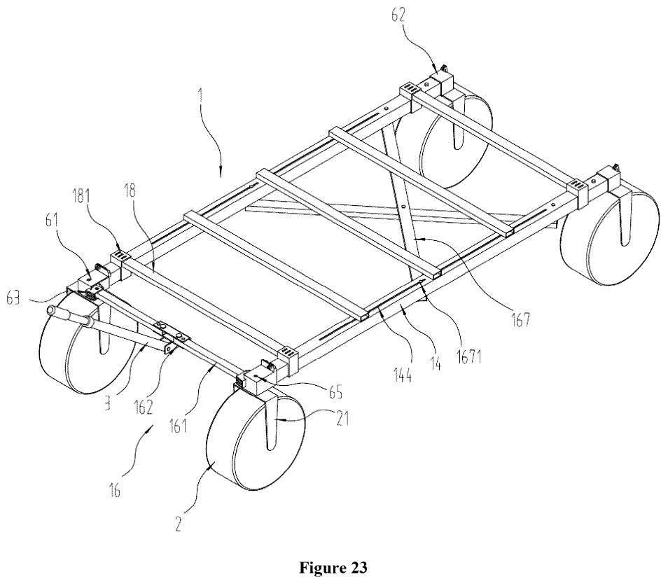

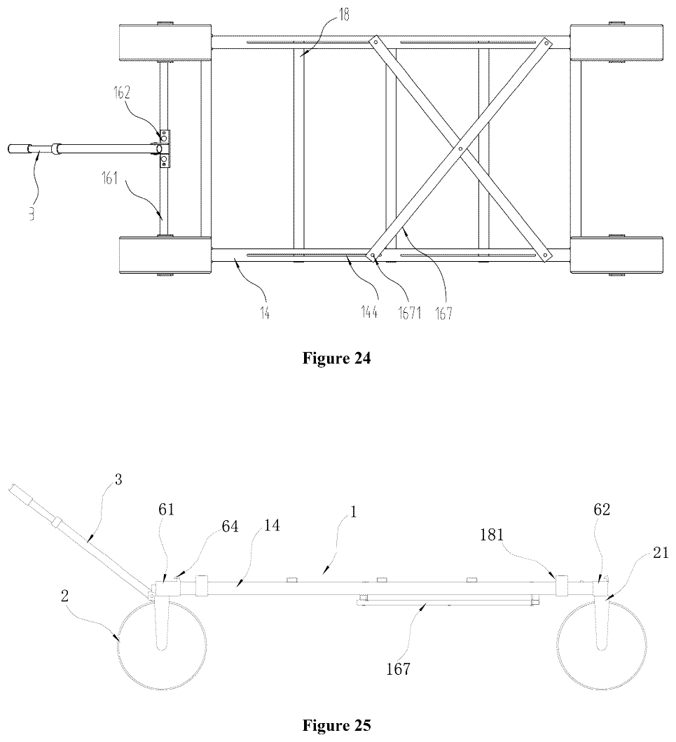

As illustrated in FIGS. 23 and 24, the weight of items placed in the storage assembly 5 increases the load on the frame 1. To improve the frame's support reliability, a preferred implementation includes the addition of support bars 18 to the frame 1.

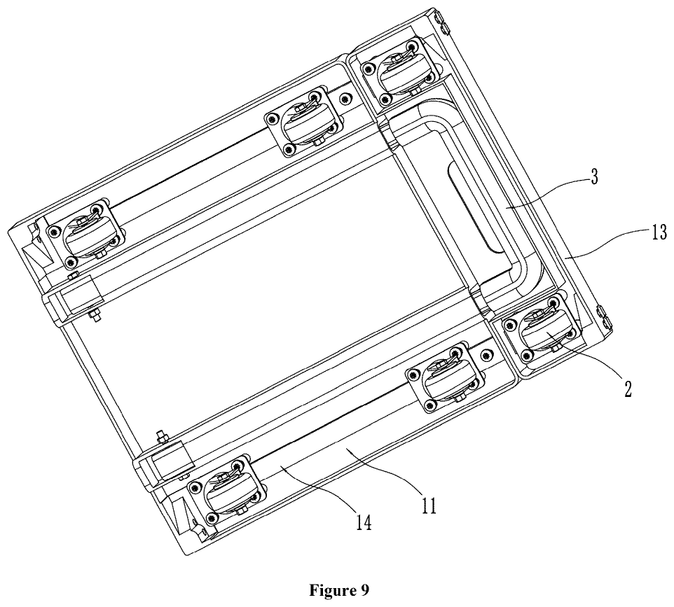

The support bars 18 are multiple in number and span across the pair of support rods 14. Both ends of each support bar 18 are equipped with clamping elements 181 that fit securely onto the pair of support rods 14, as shown in FIG. 9. The upper end of each clamping element 181 has a slot that engages with the end of a support bar 18. The lower part of each clamping element 181 features a pair of downward extensions 182, which culminate in inwardly extending hooks 183. These clamping elements 181 can be made of plastic, providing flexibility to allow the hooks 183 to grip the support rods 14 securely, thereby fixing the support bars 18 in place.

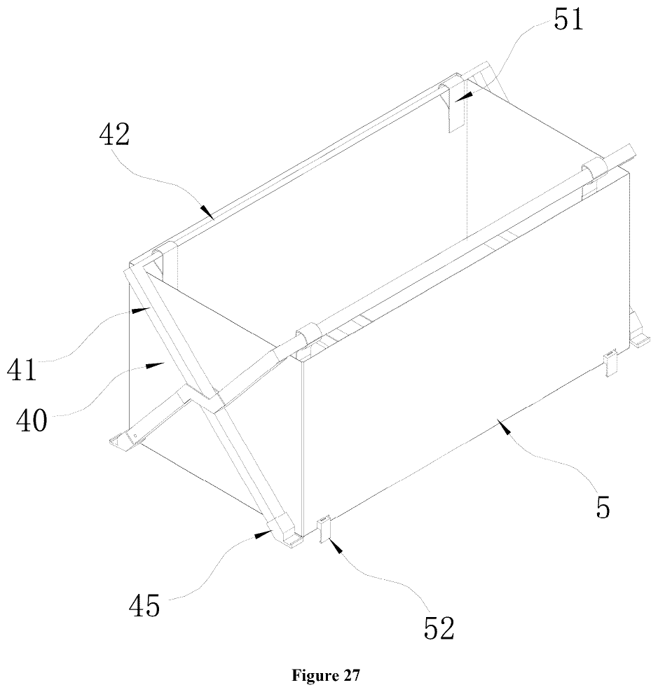

Referring to FIGS. 22 and 27, the storage assembly 5 in this scheme can be a storage bag or a storage box. The upper end of the storage bag or box connects to the support frame 4 and is intended to hold items for transport. The lower end of the storage bag or box can be positioned against the frame 1 or spaced apart from it, or it can be secured using fastening straps or U-shaped connecting buckles 52 on the support rods 14.

As highlighted in FIG. 4, to improve the uniformity and reliability of the load-bearing capacity of the frame 1 in supporting the storage assembly 4, a preferred implementation includes the use of support fabric 19 in the frame 1. The support fabric 19 is made of multiple layers of material, with the support bars 18 running horizontally through it and the fabric extending beyond the ends of the support bars 18.

In this scheme, because the support bars 18 are detachably connected to the support rods 14 of the frame 1, the support fabric 19 can be combined with the support frame 4 by removing the support bars 18. This arrangement allows the support fabric 19 to be repurposed as a temporary table. The ends of the support bars 18 can be attached to the second connecting rod 42 of the support frame 4 using the clamping elements 181. Since this arrangement resembles a common scissor-type folding table, further details and illustrations are not provided in this description.

In the structural implementation of the frame 1, a preferred implementation example includes a connecting assembly 16 comprising: a first traction rod 161, a connecting seat 162, and a scissor rod 167.

The first traction rod 161 is provided in a pair, each corresponding to one of the first connecting blocks 61. One end of the first traction rod 161 is inserted into the rotating connection part 63 of its corresponding first connecting block 61 and is rotatably connected within the rotating connection part 63. The rotating connection part 63, away from the open side of its U-shaped structure, forms a limiting structure 631 that restricts the rotation of the first traction rod 161.

The connecting seat 162 is positioned between the pair of first traction rods 161. The other ends of the first traction rods 161 are rotatably connected to the connecting seat 162. One end of the pulling rod 3 is connected to the connecting seat 162 through a rotating part. The other end of the pulling rod 3 can pivot up or down around the rotating connection part with the connecting seat 162.

The scissor rod 167 is provided in a pair, with a scissor-like central pivot. The pair of scissor rods 167 is positioned between the pair of support rods 14. One end of each scissor rod 167 is rotatably connected to the other end of the respective support rods 14. The other ends of the scissor rods 167 are relatively movably connected to the ends of the support rods 14 through movable connectors.

The movable connector includes a guide rod 1671. Each end of the pair of support rods 14 features a guide slot 144. The other ends of the scissor rods 167 are slidably connected with the guide slots 144 through the guide rods 1671.

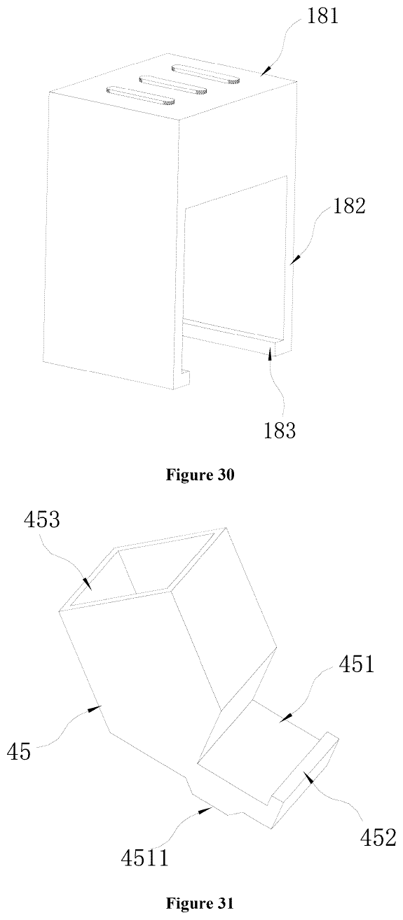

Based on FIGS. 22 to 26, and referring to FIG. 29 or 30, the limiting structure 631 of the first connecting block 61 restricts the rotation of the first traction rod 161. The rotating connection part 63 may have a first pin hole 632 to accommodate a pin at the end of the first traction rod 161 for rotational engagement. Specifically, a pin at the end of the first traction rod 161 fits into the first pin hole 632, enabling rotational connection with the rotating connection part 63.

When the device is in use, the user pulls the pulling rod 3 forward, causing the first traction rod 161 to rotate and thereby unfolding the support rods 14 of the frame 1. The support frame 4 and storage assembly 5 are then sequentially placed on the frame 1. As the user continues to pull the pulling rod 3 forward, the frame 1 moves, with the limiting structure 631 ensuring that the first traction rod 161 is constrained when it reaches a position perpendicular or at a specific angle to the support rods 14, preventing further deformation of the frame 1. For storage, the user can detach the storage assembly 5 and the support frame 4 in sequence, then push the pulling rod 3 in the opposite direction to fold and compact the frame 1.

In this implementation, the wheels 2 are provided in pairs, each pair corresponding to one of the first connecting blocks 61 and one of the second connecting blocks 62. The wheels 2 are attached to the first connecting blocks 61 or the second connecting blocks 62 through wheel mounting components. For ease of installation, the first connecting block 61 and the second connecting block 62 may be provided with wheel mounting holes 65 to engage with the wheel mounting components 21 on the wheels 2.

### Embodiment 8

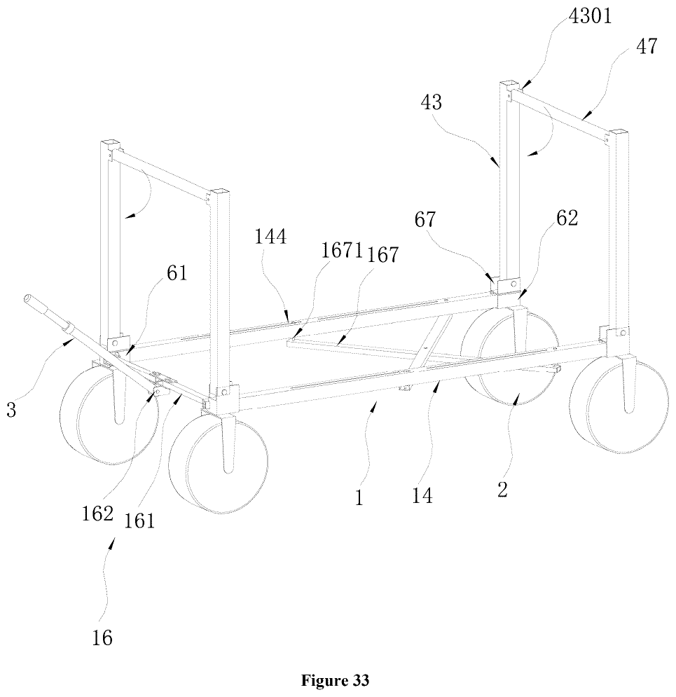

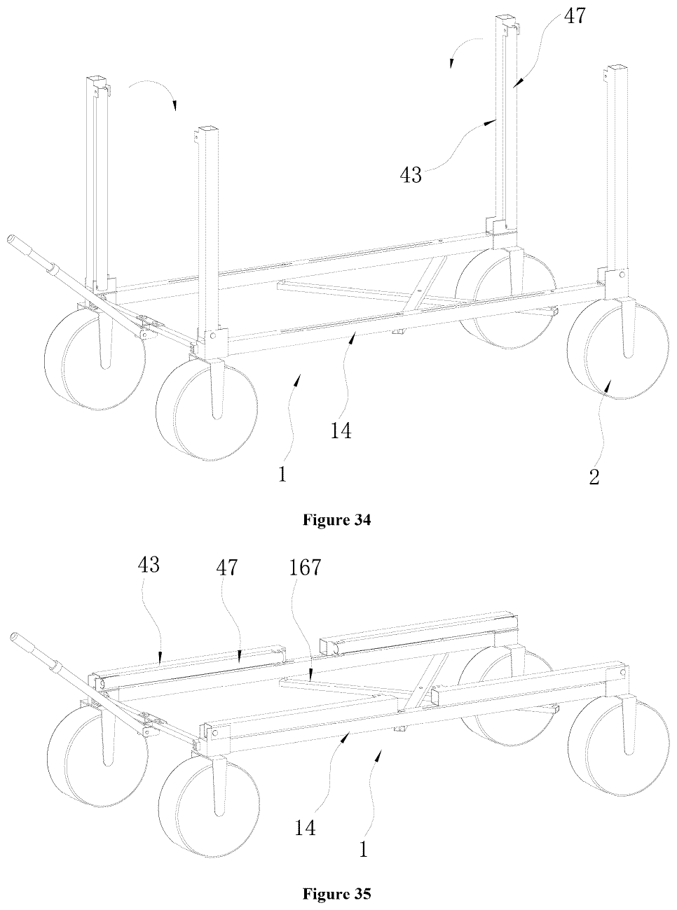

As illustrated in one of FIGS. 33 to 35, this embodiment is generally similar to Embodiment 7. The difference lies in the structure of the support frame 4. In this embodiment, the support frame 4 includes support rods 43 and crossbars 47.

The support rods 43 are provided in pairs, each pair corresponding to a pair of first connecting blocks 61 and second connecting blocks 62. The upper ends of both the first connecting blocks 61 and the second connecting blocks 62 are equipped with rotating connection seats 67. One end of each pair of support rods 43 is rotatably connected to the corresponding first connecting block 61 or second connecting block 62 via a rotating pin shaft. The support rods 43 have a support state and a folded state. In the support state, the other end of the support rods 43 flips upward around the rotating pin shaft to be perpendicular to the support rods 14. In the folded state, the other end of the support rods 43 folds downward to lie adjacent to the support rods 14.

The crossbars 47 are also provided in pairs. One crossbar 47 of the pair connects to the other ends of the support rods 43 linked to the first connecting blocks 61, while the other crossbar 47 connects to the other ends of the support rods 43 linked to the second connecting blocks 62.

When the support rods 43 are in the support state, they form an enclosed space between the pairs of support rods 43, designed to hold the storage assembly 5. The storage assembly 5 is connected to the support rods 43 or the crossbars 47.

To facilitate folding, the other ends of the support rods 43 may include connecting parts 4301 for connecting with the crossbars 47. One end of the crossbar 46 can be connected to the connecting part 4301 via a rotating pin, while the other end can be detachably connected to another connecting part, for example, by lap joints or snap fits. FIGS. 33, 34, and 35 sequentially illustrate the transition of the support frame 4 from the support state to the folded state. This structure greatly facilitates the storage of the transport device and the installation and removal of the storage assembly.

The above embodiments are only part of the examples of the disclosure and do not limit the scope of protection of the disclosure. Any equivalent devices or equivalent process changes made using the content of the disclosure specification and drawings, or directly or indirectly applied to other related technical fields, are included within the patent protection scope of the disclosure.

1. A transport device, comprising:
a frame;
casters disposed at a lower part of the frame;
a pull rod connected to one end of the frame for moving the frame;
characterized in that the transport device further comprises:
a support frame detachably connected to an upper end of the frame;
a storage assembly disposed on the frame, wherein the storage assembly is connected to the support frame and configured to accommodate items to be transported.

2. The transport device of claim 1, wherein upper end sides of the frame are provided with connection slots corresponding to the support frame, and a lower end of the support frame is detachably insertable into the connection slots;
wherein a lower part of the storage assembly is detachably connected to the frame;
and/or wherein the connection slots are provided with constraint holes; the lower end of the support frame is provided with constraint components corresponding to the constraint holes; the constraint components have a locked state and an unlocked state with respect to the constraint holes;
in the locked state, the constraint components penetrate into the constraint holes, securing the lower end of the support frame in the connection slots;
and in the unlocked state, the constraint components disengage from the constraint holes, allowing the lower end of the support frame to be removed from the connection slots;
wherein the storage assembly includes a space for accommodating items to be transported, with an upper end detachably connected to upper ends of the pair of support frames, and a lower end extending downwards toward the frame.

3. The transport device of claim 2, wherein the support frame comprises a first connecting frame and a second connecting rod;
the first connecting frames are provided with pairs and disposed oppositely on both sides of the upper end of the frame, each first connecting frame including a pair of first connecting rods connected in a scissor-like manner; the lower ends of the pair of first connecting rods correspond to the connection slots on the frame; the constraint components are provided at the lower ends of the first connecting rods, and the lower ends of the first connecting rods are detachably connected to the connection slots via the constraint components;
the second connecting rods are provided with pairs and disposed parallel to each other between the pair of first connecting frames; ends of the pair of second connecting rods are fixedly connected to upper ends of the pair of first connecting rods of the first connecting frames;
wherein in the locked state, the constraint components penetrate into the constraint holes, securing the first connecting rods in the connection slots;
and wherein in the unlocked state, the constraint components disengage from the constraint holes, allowing the first connecting rods to be removed from the connection slots.

4. The transport device of claim 2, wherein the support frame comprises a support rod and a second connecting frame;
the support rod is provided with pairs and disposed oppositely on both sides of the upper end of the frame, with lower ends of the support rods being detachably insertable into the connection slots; the constraint components are provided at the lower ends of the support rods, and the lower ends of the support rods are detachably connected to the connection slots via the constraint components;
the second connecting frame is provided with pairs and disposed oppositely between the adjacent support rods, each second connecting frame including a pair of second connecting rods connected in a scissor-like manner; upper ends of the pair of second connecting rods are rotatably connected to upper ends of the corresponding support rods; lower ends of the pair of second connecting rods are slidably connected to middle parts of the corresponding support rods via sliding members, and the second connecting rods are rotatably connected to the sliding members;
wherein in the locked state, the constraint components penetrate into the constraint holes, securing the support rods in the connection slots;
and wherein in the unlocked state, the constraint components disengage from the constraint holes, allowing the support rods to be removed from the connection slots.

5. The transport device of any one of claims 1 to 4, wherein the frame comprises a chassis;
the chassis has a rectangular plate structure; the casters are disposed at corners of a lower end of the chassis; connection slots are provided on both sides of an upper end of the chassis;
wherein the chassis comprises an accommodation slot for accommodating the pull rod, with one end of the slot extending to one end of the chassis; and one end of the pull rod is rotatably connected to one end of the accommodation slot.

6. The transport device of claim 5, wherein the chassis comprises a first chassis, a second chassis, and a guide rod;
the first chassis has a rectangular plate structure; the slot is provided on the first chassis; casters are disposed at corners of a lower end of the first chassis;
the second chassis has a rectangular plate structure; casters are disposed at lower ends of both sides of the second chassis;
the guide rod is provided with pairs and disposed parallel and opposite to each other; one end of each guide rod is connected to an end of the second chassis near the first chassis; the first chassis is provided with guide slots corresponding to the pair of guide rods, and the other end of the pair of guide rods can be slidably inserted into the guide slots;
wherein the connection slots are provided on both sides of the first chassis and the second chassis, which are opposite to each other;
additionally, the guide slots are detachably provided with locking members; the guide rods are intermittently provided with multiple locking holes for cooperating with the locking members; the locking members and the locking holes have a fixed constraint state and a released constraint state; in the fixed constraint state, the locking members pass through the slots and cooperate with one of the locking holes to secure the guide rods in the slots; in the released constraint state, the locking members disengage from the locking holes, allowing the guide rods to be slidably removed from the guide slots;
alternatively, a bottom of the second chassis corresponding to one end of the guide rods is provided with a connection part; the connection part is provided with fixing members that are fixedly matched with the guide rods; an end of the guide rods inserted into the slots is provided with anti-detachment parts to prevent the guide rods from coming out of the guide slots.

7. The transport device of any one of claims 2 to 4, wherein the frame is configured to fold or expand in a width direction; the frame comprising a support rod, a connecting assembly, and a constraint assembly;
the support rod is provided with pairs and disposed parallel and opposite to each other; the casters are connected to lower ends of the support rods; the connection slots are respectively provided at both ends of the support rods;
the connecting assembly is connected to the pair of support rods, and configured to move the pair of support rods to fold or expand the frame in the width direction;
the constraint assembly is connected to at least one of the pair of support rods and/or the connecting assembly, configured to maintain the frame in an expanded locked state or allow folding in the width direction in an unlocked state.

8. The transport device of claim 7, wherein the connecting assembly comprises a first traction rod, and a connecting seat;
the first traction rod is provided with pairs, and each corresponding to one of the support rods; one end of each first traction rod is rotatably connected to one end of the support rods;
the connecting seat is positioned between the pair of first traction rods; the other ends of the first traction rods are rotatably connected to the connecting seat;
wherein one end of the pull rod is connected to the connecting seat via a rotating component, allowing the other end of the pull rod to flip up or down around the end connected to the connecting seat.

9. The transport device of claim 7, wherein connecting assembly further comprises a third connecting rod;
the third connecting rod is provided with pairs, and are connected in the middle in a scissor-like manner; the pair of third connecting rods are positioned between the pair of support rods, with one end of each third connecting rod rotatably connected to the other end of the support rods; the other ends of the third connecting rods are connected via movable connecting components, allowing relative movement between the ends of the third connecting rods and the support rods;
when the constraint assembly and the connecting assembly are in an unlocked state, and the pair of support rods of the frame move toward or away from each other, the other ends of the third connecting rods move relative to the support rods, enabling the frame to fold or unfold along the width direction.

10. The transport device of claim 1, further comprising a installation assembly;
the installation assembly is arranged on the frame;
the support frame is connected to the frame through the installation assembly.

11. The transport device of claim 10, wherein the frame comprises a support rod and a connecting assembly;
the support rod is provided with pairs and are arranged horizontally and opposite to each other; the casters are connected to the lower ends of the support rods.
the connecting assembly is connected to the pair of support rods, providing lateral support and enabling the support rods to move, thereby allowing the frame to fold or unfold along the width direction;
the connecting assembly is also connected to the installation assembly, which is equipped with a limit structure to restrict the width expansion of the frame.

12. The transport device of claim 11, wherein the installation assembly comprises a first connecting block and a second connecting block;
the first connecting block is provided with pairs, and correspond to the support rods, with one end of each first connecting block provided with a slot that fits with one end of the support rods; the opposite side of the pair of first connecting blocks is equipped with a U-shaped rotating connection part;
the second connecting block is provided with pairs, and correspond to the pair of support rods, with one end of each second connecting block provided with a slot that fits with the other end of the support rods;
the connecting assembly is rotatably connected to the U-shaped rotating connection parts of the pair of first connecting blocks; a closed side of the U-shaped structure forms a limit structure that restricts the rotational range of the connecting assembly relative to the rotating connection part;
the support frame is connected to the upper ends of the pair of first connecting blocks and the pair of second connecting blocks.

13. The transport device of claim 12, wherein the support frame is detachably connected to the upper ends of the pair of first connecting blocks and the pair of second connecting blocks using fitting components; upper ends of the first and second connecting blocks are each provided with lugs that cooperate with the fitting components; the lugs and the upper surfaces of the first or second connecting blocks form a constraint area, where the fitting components are inserted to engage detachably with the lugs; the support frame includes a pair of first connecting frames and a pair of second connecting rods;
the pair of first connecting frames are positioned opposite each other at the ends of the pair of support rods; each first connecting frame comprises a pair of first connecting rods connected in a scissor-like manner; a lower end of the pair of first connecting rods of one of the first connecting frames is detachably connected to the lugs on an upper end of the first connecting blocks at one end of the support rods, using fitting components; the lower end of the first connecting rods of the other one of the first connecting frames is detachably connected to the lugs on an upper end of the second connecting blocks at the other end of the support rods, using fitting components;
the second connecting rod is provided with pairs and are a pair arranged parallel to each other between the pair of first connecting frames; the ends of the second connecting rods are fixedly connected to the upper ends of the corresponding first connecting rods of the first connecting frames;
the pair of second connecting rods and the pair of first connecting frames form a constrained space between them, designed to hold the storage assembly, which is connected to the pair of second connecting rods.

14. The transport device of claim 13, wherein the fitting component comprises mounting sleeves;
the mounting sleeves are cylindrical housings that match the ends of the first connecting rods; the ends of the first connecting rods are inserted into the cylindrical housings of the mounting sleeve; the mounting sleeves are equipped with extension parts designed to insert into the constraint area and engage detachably with the lugs; the end of each extension part features an upward-bending hook; the upward-bending hook cooperates with the lugs to prevent the mounting sleeve from detaching from the constraint area in a first direction; the first direction is perpendicular to or forms an angle with the direction in which the extension parts insert into the constraint area;
the upper end surface of the first or second connecting blocks is further provided with guide slots that direct the extension parts into the constraint area; the lower end surface of the extension parts features guide protrusions corresponding to the guide slots.

15. The transport device of claim 12, wherein the support frame comprises a support rod and a crossbar;
the support rods is provided with two pairs, each pair corresponding to a pair of first connecting blocks and a pair of second connecting blocks; the upper ends of the first and second connecting blocks are equipped with rotating connection seats; one end of each pair of support rods is rotatably connected to the rotating connection seats on the upper ends of the corresponding first or second connecting blocks via rotating pin shafts; the support rods have a support state and a folded state; in the support state, the other end of the support rods flips upwards around the rotating pin shafts to a position perpendicular to the support rods; in the folded state, the other end of the support rods folds down to lie flat against the support rods;
the crossbar is provided with a pair; one of the pair of crossbars connects the other ends of the support rods associated with the pair of first connecting blocks, while the other crossbar connects the other ends of the support rods associated with the pair of second connecting blocks;
in the support state, the two pairs of support rods form an enclosed space between them, which serves as a constraint area for the storage assembly; the storage assembly is connected to the support rods or the crossbars.

16. The transport device of claim 15, wherein the frame further comprises support ribs;
the support rib is provided with multiple and span across the pair of support rods; the ends of the support ribs are equipped with clamping components that securely fit with the pair of support rods.

17. The transport device of claim 13, wherein the connecting assembly includes a pair of first traction rod, a connecting seat, and a scissor rod;
the first traction rod is provided with a pair, and corresponds to the pair of first connecting blocks; one end of each first traction rod is inserted into the rotating connection part of its corresponding first connecting block and is rotatably connected therein; the side of the rotating connection part opposite the open side of the U-shaped structure forms a limit structure that restricts the rotation of the first traction rod;
the connecting seat is positioned between the pair of first traction rods; the other ends of the first traction rods are rotatably connected to the connecting seat; one end of the pull rod is connected to the connecting seat via a rotating component, allowing the other end of the pull rod to flip up or down around the end connected to the connecting seat;
the scissor rod is provided with a pair, and are connected in the middle in a scissor-like manner; the pair of scissor rods are positioned between the pair of support rods, with one end of each scissor rod rotatably connected to the other ends of the support rods; the other ends of the scissor rods are connected to the support rods via movable connecting components, allowing relative movement;
the movable connecting components are guide rods, with guide slots located between the ends of the pair of support rods; the other ends of the scissor rods are slidably connected to the guide slots via the guide rods.

18. The transport device of claim 16, wherein the frame further comprises a support fabric. the support fabric is made of a multi-layered material structure, with multiple support ribs horizontally inserted within the fabric, leaving the ends of the ribs exposed outside the support fabric.
there are two pairs of casters, corresponding respectively to the pair of first connecting blocks and the pair of second connecting blocks; the casters are attached to the first or second connecting blocks via caster mounting components;
the storage assembly is a storage bag or storage box; the upper end of the storage bag or storage box is connected to the support frame and is used for holding items to be transported; the lower end of the storage bag or storage box can either lie flat against the frame, form a gap, or be secured with straps or U-shaped buckles attached to the support rods.

19. A camping cart, wherein the camping cart comprises the transport device of claim 1; the storage assembly is a storage bag or storage box, with an upper end of the storage assembly connected to the support frame to hold items to be transported; a lower end of the storage assembly can either lie flat against the frame, form a gap, or be secured using straps or other fastener
